(19) United States
(12) Patent Application Publication
(10) Pub. No.: US 2022/0179619 A1
(43) Pub. Date: Jun. 9, 2022

(54) ELECTRONIC DEVICE AND METHOD FOR OPERATING THEREOF

(71) Applicant: Samsung Electronics Co., Ltd., Gyeonggi-do (KR)

(72) Inventors: Jungkeun CHO, Gyeonggi-do (KR); Donghee SUH, Gyeonggi-do (KR); Minju KIM, Gyeonggi-do (KR); Jaeyung YEO, Gyeonggi-do (KR)

(21) Appl. No.: 17/541,930

(22) Filed: Dec. 3, 2021

Related U.S. Application Data
(63) Continuation of application No. PCT/KR2021/015036, filed on Oct. 25, 2021.

(30) Foreign Application Priority Data
Dec. 3, 2020 (KR) 10-2020-0167542

(51) Int. Cl. G06F 3/16; G06Q 10/10

(52) U.S. Cl. CPC G06F 3/167; G06F 15/0266; G06Q 10/1093

(57) ABSTRACT

An electronic device is disclosed, and may include a communication circuit, a memory, and a processor operatively connected to the communication circuit and the memory. The memory stores instructions that, when executed, cause the processor to recognize a second external device that will perform an operation corresponding to a first utterance received by a first external device, to establish a first session between the first external device and the second external device, to recognize a device, which will perform an operation corresponding to a second utterance received by a third external device, while maintaining the first session, to determine whether to establish a second session between the third external device and the second external device based on a specified first condition when the device that will perform the operation corresponding to the second utterance is the second external device, and to establish the second session independently of the first session or establish an integrated session between the first external device, the second external device, and the third external device by integrating the first session and the second session when establishing the second session, on a basis of a specified second condition.

### CROSS-REFERENCE TO RELATED APPLICATION(S)

This application is a continuation of, and claims priority under 35 U.S.C. § 120 to, International Application No. PCT/KR2021/015036, which was filed on Oct. 25, 2021, and claims priority under 35 U.S.C. § 119 to Korean Patent Application No. 10-2020-0167542, filed on Dec. 3, 2020, in the Korean Intellectual Property Office, the disclosure of which is incorporated herein by reference in its entirety.

### BACKGROUND

### 1. Field

The present disclosure relates to controlling a plurality of electronic devices through speech recognition.

### 2. Description of the Related Art

With the development of a speech recognition technology, a speech recognition function may be implemented in various electronic devices including microphones. For example, an intelligent assistance service capable of providing an intuitive interface between electronic devices has recently been developed. The intelligent assistance service may infer a user's intent by performing natural language processing on the user's utterance, and may allow a control device to be controlled based on the inferred intent of the user. In particular, there is an increasing need for a technology capable of organically transmitting and receiving information between a plurality of electronic devices through speech recognition and seamlessly performing operations corresponding to utterances. For example, in a multi-device environment including a plurality of electronic devices (hereinafter, this may be used interchangeably with the term “listener”) receiving a user's utterance and an electronic device (hereinafter, this may be used interchangeably with the term “executor”) performing an operation corresponding to the utterance, there is a need for a method capable of smoothly performing an operation corresponding to the utterance depending on the user's intent.

### SUMMARY

According to an embodiment, an operation according to utterance may be performed seamlessly in a multi-device environment.

According to an embodiment, an operation corresponding to a user's utterance received by a plurality of listeners may be performed by a single executor.

According to an embodiment, the generation, release, integration, or separation of a connection (e.g., session) between a plurality of listeners and an executor may be managed depending on situations.

According to an embodiment, it is possible to provide a result of processing a user utterance in a suitable form in each device of a listener and an executor, depending on a connection (e.g., a session) state between the executor and a plurality of listeners.

According to an embodiment, it is possible to provide a system that manages connection information between a listener and an executor, processes a request according to a user utterance by generating, cancelling, or integrating a newly-established session between the listener and the executor, and selectively provides (synchronizes) the result processed by the executor to the listener establishing a session with the executor.

Various embodiments of the present disclosure provides an electronic device capable of seamlessly processing an utterance in a multi-device environment, and an operating method of the electronic device.

Various embodiments of the present disclosure provides an electronic device capable of managing the generation, release, or integration of a connection (e.g., a session) between an executor and a plurality of listeners depending on situations, and an operating method of the electronic device.

According to an embodiment, an electronic device may include a communication circuit, a memory, and a processor operatively connected to the communication circuit and the memory. The memory stores instructions that, when executed, cause the processor to recognize a second external device that will perform an operation corresponding to a first utterance received by a first external device, to establish a first session between the first external device and the second external device, to recognize a device, which will perform an operation corresponding to a second utterance received by a third external device, while maintaining the first session, to determine whether to establish a second session between the third external device and the second external device based on a specified first condition when the device that will perform the operation corresponding to the second utterance is the second external device, and to establish the second session independently of the first session or establish an integrated session between the first external device, the second external device, and the third external device by integrating the first session and the second session when establishing the second session, on a basis of a specified second condition.

According to an embodiment, an operating method of an electronic device may include recognizing a second external device that will perform an operation corresponding to a first utterance received by a first external device, establishing a first session between the first external device and the second external device, recognizing a device, which will perform an operation corresponding to a second utterance received by a third external device, while maintaining the first session, determining whether to establish a second session between the third external device and the second external device based on a specified first condition when the device that will perform the operation corresponding to the second utterance is the second external device, and establishing the second session independently of the first session or establishing an integrated session between the first external device, the second external device, and the third external device by integrating the first session and the second session when establishing the second session, on a basis of a specified second condition.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment, according to various embodiments;

FIG. 2 illustrates an integrated intelligence system, according to an embodiment;

FIG. 3 illustrates the form in which relationship information between a concept and an action is stored in a database, according to an embodiment;

FIG. 4 illustrates a user terminal displaying a screen of processing a voice input received through an intelligent app, according to an embodiment;

FIG. 5 illustrates an intelligent assistance system, according to an embodiment;

FIG. 6 is a view illustrating a configuration of an electronic device, according to an embodiment;

FIG. 7 is a view illustrating a configuration of an electronic device, according to an embodiment;

FIG. 8 is a diagram illustrating an operation of an intelligent assistance system, according to an embodiment;

FIG. 9 is a diagram illustrating a session management operation of an intelligent assistance system, according to an embodiment;

FIG. 10 is a flowchart illustrating a session management operation of an intelligent assistance system, according to an embodiment;

FIG. 11 is a diagram illustrating a session management operation of an intelligent assistance system, according to an embodiment;

FIG. 12 is a diagram illustrating a session management operation of an intelligent assistance system, according to an embodiment;

FIGS. 13A to 13D are diagrams illustrating examples of establishing a session, according to various embodiments;

FIG. 14 is a flowchart of an operating method of an electronic device, according to an embodiment;

FIG. 15 is a flowchart of an operating method of an electronic device, according to an embodiment;

FIG. 16 is a flowchart of an operating method of an electronic device, according to an embodiment;

FIG. 17 is a flowchart of an operating method of an electronic device, according to an embodiment;

FIG. 18 is a diagram illustrating an operation of an intelligent assistance system, according to an embodiment;

FIG. 19 is a diagram illustrating an operation of an intelligent assistance system, according to an embodiment;

FIG. 20 is a diagram illustrating an operation of an intelligent assistance system, according to an embodiment;

FIG. 21 is a diagram illustrating an operation of an intelligent assistance system, according to an embodiment;

FIG. 22 is a diagram illustrating an operation of an intelligent assistance system, according to an embodiment;

FIG. 23 is a diagram illustrating an operation of an intelligent assistance system, according to an embodiment;

FIG. 24 is a diagram illustrating an operation of an intelligent assistance system, according to an embodiment;

FIG. 25 is a diagram illustrating an operation of an intelligent assistance system, according to an embodiment; and

FIG. 26 is a diagram illustrating an operation of an intelligent assistance system, according to an embodiment.

With regard to description of drawings, the same or similar components will be marked by the same or similar reference signs.

### DETAILED DESCRIPTION

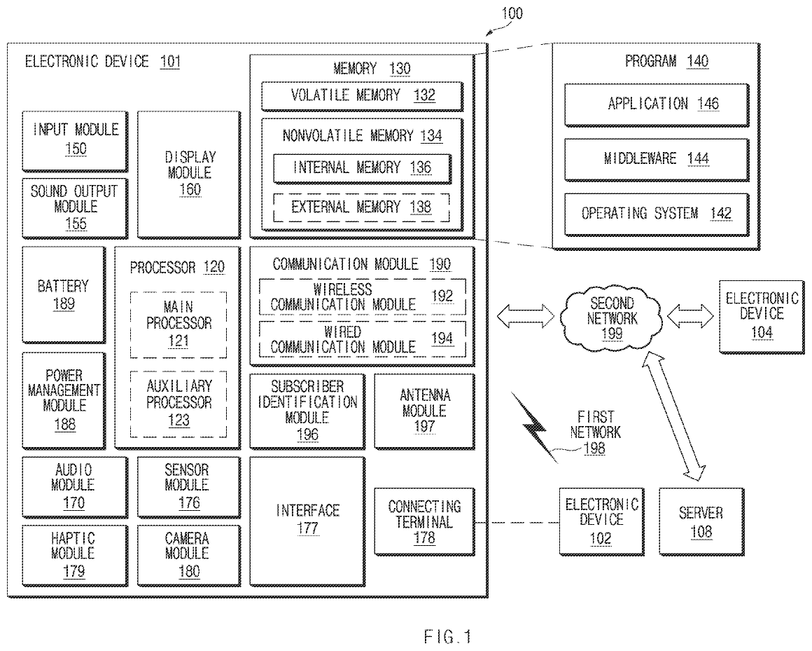

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form an mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

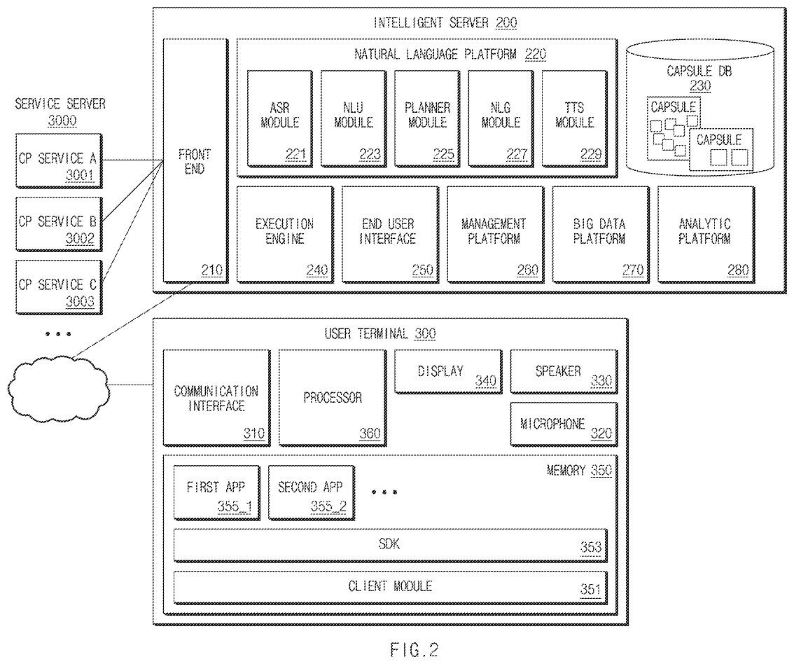

FIG. 2 illustrates an integrated intelligence system, according to an embodiment.

Referring to FIG. 2, an integrated intelligence system according to an embodiment may include a user terminal 300, an intelligent server 200, and a service server 3000.

The user terminal 300 according to an embodiment may be a terminal device (or an electronic device) capable of connecting to Internet, and may be, for example, a mobile phone, a smartphone, a personal digital assistant (PDA), a notebook computer, a television (TV), a household appliance, a wearable device, a head mounted display (HMD), or a smart speaker.

According to the illustrated embodiment, the user terminal 300 may include a communication interface 310, a microphone 320, a speaker 330, a display 340, a memory 350, and/or a processor 360. The listed components may be operatively or electrically connected to one another.

The communication interface 310 according to an embodiment may be connected to an external device and may be configured to transmit or receive data to or from the external device. The microphone 320 according to an embodiment may receive a sound (e.g., a user utterance) to convert the sound into an electrical signal. The speaker 330 according to an embodiment may output the electrical signal as sound (e.g., voice). The display 340 according to an embodiment may be configured to display an image or a video. The display 340 according to an embodiment may display the graphic user interface (GUI) of the running app (or an application program).

The memory 350 according to an embodiment may store a client module 351, a software development kit (SDK) 353, and a plurality of apps 355. The client module 351 and the SDK 353 may constitute a framework (or a solution program) for performing general-purposed functions. Furthermore, the client module 351 or the SDK 353 may constitute the framework for processing a voice input.

The plurality of apps 355 may be programs for performing a specified function. According to an embodiment, the plurality of apps 355 may include a first app 355_1 and/or a second app 355_2. According to an embodiment, each of the plurality of apps 355 may include a plurality of actions for performing a specified function. For example, the apps may include an alarm app, a message app, and/or a schedule app. According to an embodiment, the plurality of apps 355 may be executed by the processor 360 to sequentially execute at least part of the plurality of actions.

According to an embodiment, the processor 360 may control overall operations of the user terminal 300. For example, the processor 360 may be electrically connected to the communication interface 310, the microphone 320, the speaker 330, and the display 340 to perform a specified operation. For example, the processor 360 may include at least one processor.

Moreover, the processor 360 according to an embodiment may execute the program stored in the memory 350 so as to perform a specified function. For example, according to an embodiment, the processor 360 may execute at least one of the client module 351 or the SDK 353 so as to perform a following operation for processing a voice input. The processor 360 may control operations of the plurality of apps 355 via the SDK 353. The following actions described as the actions of the client module 351 or the SDK 353 may be the actions performed by the execution of the processor 360.

According to an embodiment, the client module 351 may receive a voice input. For example, the client module 351 may receive a voice signal corresponding to a user utterance detected through the microphone 320. The client module 351 may transmit the received voice input (e.g., a voice input) to the intelligence server 200. The client module 351 may transmit state information of the user terminal 300 to the intelligence server 200 together with the received voice input. For example, the state information may be execution state information of an app.

According to an embodiment, the client module 351 may receive a result corresponding to the received voice input. For example, when the intelligence server 200 is capable of calculating the result corresponding to the received voice input, the client module 351 may receive the result corresponding to the received voice input. The client module 351 may display the received result on the display 340.

According to an embodiment, the client module 351 may receive a plan corresponding to the received voice input. The client module 351 may display, on the display 340, a result of executing a plurality of actions of an app depending on the plan. For example, the client module 351 may sequentially display the result of executing the plurality of actions on a display. For another example, the user terminal 300 may display only a part of results (e.g., a result of the last action) of executing the plurality of actions, on the display.

According to an embodiment, the client module 351 may receive a request for obtaining information necessary to calculate the result corresponding to a voice input, from the intelligence server 200. According to an embodiment, the client module 351 may transmit the necessary information to the intelligence server 200 in response to the request.

According to an embodiment, the client module 351 may transmit, to the intelligence server 200, information about the result of executing a plurality of actions depending on the plan. The intelligence server 200 may identify that the received voice input is correctly processed, using the result information.

According to an embodiment, the client module 351 may include a speech recognition module. According to an embodiment, the client module 351 may recognize a voice input for performing a limited function, via the speech recognition module. For example, the client module 351 may launch an intelligence app for processing a specific voice input by performing an organic action, in response to a specified voice input (e.g., wake up!).

According to an embodiment, the intelligent server 200 may receive information associated with a user's voice input from the user terminal 300 over a communication network. According to an embodiment, the intelligent server 200 may convert data associated with the received voice input to text data. According to an embodiment, the intelligence server 200 may generate at least one plan for performing a task corresponding to the user's voice input, based on the text data.

According to an embodiment, the plan may be generated by an artificial intelligence (AI) system. The AI system may be a rule-based system, or may be a neural network-based system (e.g., a feedforward neural network (FNN) and/or a recurrent neural network (RNN)). Alternatively, the AI system may be a combination of the above-described systems or an AI system different from the above-described system. According to an embodiment, the plan may be selected from a set of predefined plans or may be generated in real time in response to a user's request. For example, the AI system may select at least one plan among a plurality of predefined plans.

According to an embodiment, the intelligent server 200 may transmit a result according to the generated plan to the user terminal 300 or may transmit the generated plan to the user terminal 300. According to an embodiment, the user terminal 300 may display the result according to the plan, on a display. According to an embodiment, the user terminal 300 may display a result of executing the action according to the plan, on the display.

The intelligent server 200 according to an embodiment may include a front end 210, a natural language platform 220, a capsule database 230, an execution engine 240, an end user interface 250, a management platform 260, a big data platform 270, and/or an analytic platform 280.

According to an embodiment, the front end 210 may receive a voice input received from the user terminal 300. The front end 210 may transmit a response corresponding to the voice input to the user terminal 300.

According to an embodiment, the natural language platform 220 may include an automatic speech recognition (ASR) module 221, a natural language understanding (NLU) module 223, a planner module 225, a natural language generator (NLG) module 227, and/or a text to speech (TTS) module 229.

According to an embodiment, the ASR module 221 may convert the voice input received from the user terminal 300 into text data. According to an embodiment, the NLU module 223 may grasp the intent of the user, using the text data of the voice input. For example, the NLU module 223 may grasp the intent of the user by performing syntactic analysis or semantic analysis. According to an embodiment, the NLU module 223 may grasp the meaning of words extracted from the voice input by using linguistic features (e.g., syntactic elements) such as morphemes or phrases and may determine the intent of the user by matching the grasped meaning of the words to the intent.

According to an embodiment, the planner module 225 may generate the plan by using a parameter and the intent that is determined by the NLU module 223. According to an embodiment, the planner module 225 may determine a plurality of domains necessary to perform a task, based on the determined intent. The planner module 225 may determine a plurality of actions included in each of the plurality of domains determined based on the intent. According to an embodiment, the planner module 225 may determine the parameter necessary to perform the determined plurality of actions or a result value output by the execution of the plurality of actions. The parameter and the result value may be defined as a concept of a specified form (or class). As such, the plan may include the plurality of actions and/or a plurality of concepts, which are determined by the intent of the user. The planner module 225 may determine the relationship between the plurality of actions and the plurality of concepts stepwise (or hierarchically). For example, the planner module 225 may determine the execution sequence of the plurality of actions, which are determined based on the user's intent, based on the plurality of concepts. In other words, the planner module 225 may determine an execution sequence of the plurality of actions, based on the parameters necessary to perform the plurality of actions and the result output by the execution of the plurality of actions. Accordingly, the planner module 225 may generate a plan including information (e.g., ontology) about the relationship between the plurality of actions and the plurality of concepts. The planner module 225 may generate the plan, using information stored in the capsule DB 230 storing a set of relationships between concepts and actions.

According to an embodiment, the NLG module 227 may change specified information into information in a text form. The information changed to the text form may be in the form of a natural language speech. The TTS module 229 according to an embodiment may change information in the text form to information in a voice form.

According to an embodiment, all or part of the functions of the natural language platform 220 may be also implemented in the user terminal 300.

The capsule DB 230 may store information about the relationship between the actions and the plurality of concepts corresponding to a plurality of domains. According to an embodiment, the capsule may include a plurality of action objects (or action information) and concept objects (or concept information) included in the plan. According to an embodiment, the capsule DB 230 may store the plurality of capsules in a form of a concept action network (CAN). According to an embodiment, the plurality of capsules may be stored in the function registry included in the capsule DB 230.

The capsule DB 230 may include a strategy registry that stores strategy information necessary to determine a plan corresponding to a voice input. When there are a plurality of plans corresponding to the voice input, the strategy information may include reference information for determining one plan. According to an embodiment, the capsule DB 230 may include a follow-up registry that stores information of the follow-up action for suggesting a follow-up action to the user in a specified context. For example, the follow-up action may include a follow-up utterance. According to an embodiment, the capsule DB 230 may include a layout registry storing layout information of information output via the user terminal 300. According to an embodiment, the capsule DB 230 may include a vocabulary registry storing vocabulary information included in capsule information. According to an embodiment, the capsule DB 230 may include a dialog registry storing information about dialog (or interaction) with the user. The capsule DB 230 may update an object stored via a developer tool. For example, the developer tool may include a function editor for updating an action object or a concept object. The developer tool may include a vocabulary editor for updating a vocabulary. The developer tool may include a strategy editor that generates and registers a strategy for determining the plan. The developer tool may include a dialog editor that creates a dialog with the user. The developer tool may include a follow-up editor capable of activating a follow-up target and editing the follow-up utterance for providing a hint. The follow-up target may be determined based on a target, the user's preference, or an environment condition, which is currently set. The capsule DB 230 according to an embodiment may be also implemented in the user terminal 300.

According to an embodiment, the execution engine 240 may calculate a result by using the generated plan. The end user interface 250 may transmit the calculated result to the user terminal 300. Accordingly, the user terminal 300 may receive the result and may provide the user with the received result. According to an embodiment, the management platform 260 may manage information used by the intelligent server 200. According to an embodiment, the big data platform 270 may collect data of the user. According to an embodiment, the analytic platform 280 may manage quality of service (QoS) of the intelligent server 200. For example, the analytic platform 280 may manage the component and processing speed (or efficiency) of the intelligent server 200.

According to an embodiment, the service server 3000 may provide the user terminal 300 with a specified service (e.g., ordering food or booking a hotel). According to an embodiment, the service server 3000 may be a server operated by the third party. According to an embodiment, the service server 3000 may provide the intelligence server 200 with information for generating a plan corresponding to the received voice input. The provided information may be stored in the capsule DB 230. Furthermore, the service server 3000 may provide the intelligence server 200 with result information according to the plan.

In the above-described integrated intelligence system, the user terminal 300 may provide the user with various intelligent services in response to a user input. The user input may include, for example, an input through a physical button, a touch input, or a voice input.

According to an embodiment, the user terminal 300 may provide a speech recognition service via an intelligent app (or a speech recognition app) stored therein. In this case, for example, the user terminal 300 may recognize a user utterance or a voice input, which is received via the microphone, and may provide the user with a service corresponding to the recognized voice input.

According to an embodiment, the user terminal 300 may perform a specified action, based on the received voice input independently, or together with the intelligent server 200 and/or the service server 3000. For example, the user terminal 300 may launch an app corresponding to the received voice input and may perform the specified action via the executed app.

According to an embodiment, when providing a service together with the intelligent server 200 and/or the service server 3000, the user terminal 300 may detect a user utterance by using the microphone 320 and may generate a signal (or voice data) corresponding to the detected user utterance. The user terminal may transmit the voice data to the intelligent server 200 by using the communication interface 310.

According to an embodiment, the intelligent server 200 may generate a plan for performing a task corresponding to the voice input or the result of performing an action depending on the plan, as a response to the voice input received from the user terminal 300. For example, the plan may include a plurality of actions for performing the task corresponding to the voice input of the user and/or a plurality of concepts associated with the plurality of actions. The concept may define a parameter to be input upon executing the plurality of actions or a result value output by the execution of the plurality of actions. The plan may include relationship information between the plurality of actions and/or the plurality of concepts.

According to an embodiment, the user terminal 300 may receive the response by using the communication interface 310. The user terminal 300 may output the voice signal generated in the user terminal 300 to the outside by using the speaker 330 or may output an image generated in the user terminal 300 to the outside by using the display 340.

In FIG. 2, it is described that speech recognition of a voice input received from the user terminal 300, understanding and generating a natural language, and calculating a result by using a plan are performed on the intelligent server 200. However, various embodiments of the disclosure are not limited thereto. For example, at least part of configurations (e.g., the natural language platform 220, the execution engine 240, and the capsule DB 230) of the intelligent server 200 may be embedded in the user terminal 300 (or the electronic device 101 of FIG. 1), and the operation thereof may be performed by the user terminal 300.

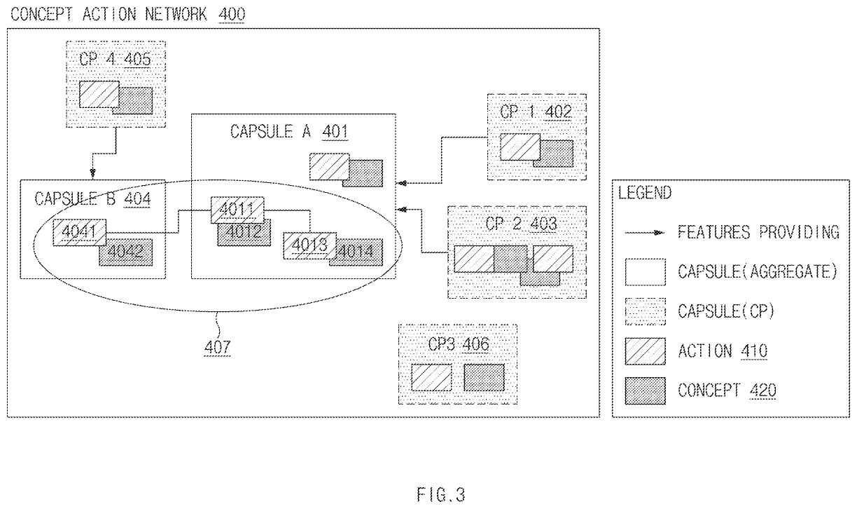

FIG. 3 illustrates a form in which relationship information between a concept and an action is stored in a database, according to an embodiment.

A capsule DB 230 of the intelligent server 200 may store a capsule in the form of a CAN. The capsule DB may store an action for processing a task corresponding to a user's voice input and a parameter necessary for the action, in the CAN form.

The capsule DB may store a plurality capsules, such as capsule A 401 and capsule B 404, respectively corresponding to a plurality of domains (e.g., applications). According to an embodiment, a single capsule (e.g., capsule A 401) may correspond to a single domain (e.g., a location (geo) or an application). Furthermore, at least one service provider (e.g., CP 1 402 or CP 2 403) for performing a function for a domain associated with the capsule may correspond to one capsule. According to an embodiment, the single capsule may include at least one or more actions 410 and at least one or more concepts 420 for performing a specified function.

The natural language platform 220 may generate a plan for performing a task corresponding to the received voice input, using the capsule stored in a capsule database. For example, the planner module 225 of the natural language platform 220 may generate the plan by using the capsule stored in the capsule database. For example, a plan 407 may be generated by using actions 4011 and 4013 and concepts 4012 and 4014 of capsule A 401 and an action 4041 and a concept 4042 of capsule B 404.

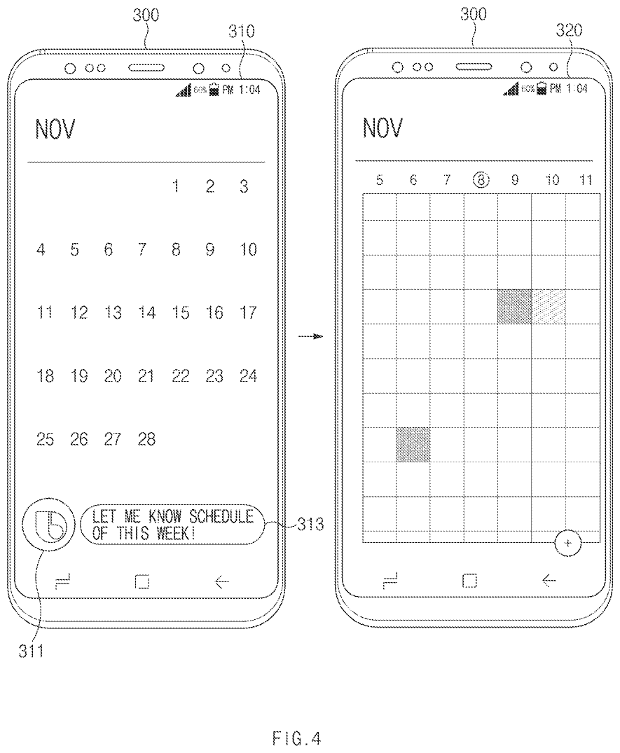

FIG. 4 illustrates a screen in which a user terminal processes a voice input received through an intelligent app, according to an embodiment.

The user terminal 300 may execute an intelligent app to process a user input through the intelligent server 200.

According to an embodiment, on screen 310, when recognizing a specified voice input (e.g., wake up!) or receiving an input via a hardware key (e.g., a dedicated hardware key), the user terminal 300 may launch an intelligent app for processing a voice input. For example, the user terminal 300 may launch the intelligent app in a state where a schedule app is executed. According to an embodiment, the user terminal 300 may display an object (e.g., an icon) 311 corresponding to the intelligent app, on the display 340. According to an embodiment, the user terminal 300 may receive a voice input by a user utterance. For example, the user terminal 300 may receive a voice input saying that “let me know the schedule of this week!”. According to an embodiment, the user terminal 300 may display a user interface (UI) 313 (e.g., an input window) of the intelligence app, in which text data of the received voice input is displayed, on a display.

According to an embodiment, on screen 320, the user terminal 300 may display a result corresponding to the received voice input, on the display. For example, the user terminal 300 may receive a plan corresponding to the received user input and may display “The schedule of this week” on the display depending on the plan.

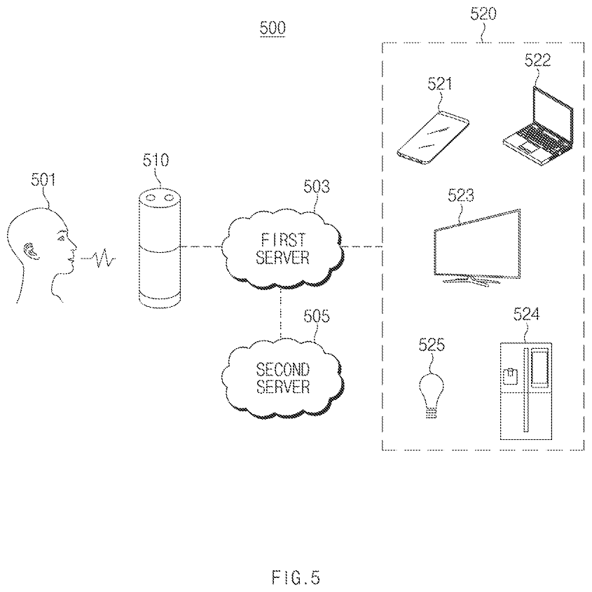

FIG. 5 illustrates an intelligent assistance system, according to an embodiment.

According to an embodiment, an intelligent assistance system 500 may include a first server 503 (e.g., the server 108 of FIG. 1 or the intelligent server 200 of FIG. 2), a second server 505 (e.g., the server 108 in FIG. 1), a device 510 (hereinafter, a “listener” is used interchangeably) (e.g., an artificial intelligence (AI) speaker) receiving at least one utterance, and a device 520 (hereinafter, an “executor” is used interchangeably) performing an operation corresponding to the at least one utterance. One listener 510 is shown in FIG. 5. However, according to various embodiments, the plurality of listeners 510 may be disposed in a predetermined space. The first server 503 and the listener 510 may be connected to each other by using a wired or wireless network, and the first server 503 and the second server 505 may also be connected to each other by using a wired or wireless network. For example, the first server 503 and the plurality of executors 520 may be connected to each other by using a wired or wireless network. For example, the listener 510 and the plurality of executors 520 may be connected through the first server 503. According to various embodiments, the disclosure is not limited thereto, and the listener 510 and the plurality of executors 520 may be connected in a device to device (D2D) manner.

According to various embodiments, the listener 510 may include various devices including a configuration associated with speech recognition and a voice input device (e.g., a microphone). For example, the listener 510 may include the electronic device 101 of FIG. 1 or the user terminal 300 of FIG. 2. According to an embodiment, the listener 510 may obtain an utterance from a user 501 through the voice input device. According to an embodiment, the utterance may include a wake-up utterance indicating activating and/or calling an intelligent assistance service and/or a control utterance indicating an operation (e.g., power control or volume control) of a hardware and/or software configuration included in the plurality of executors 520.

According to an embodiment, the wake-up utterance may be a preset keyword such as “Hi”, “Hello”, or “Hi! ABC”. For example, “ABC” in the wake-up utterance may be a name (e.g., “Bixby”) assigned to the listener 510 (or a speech recognition agent (or AI) of the listener 510), such as Galaxy.

According to an embodiment, the control utterance may be obtained while the intelligent assistance service is activated or called by the wake-up utterance. However, this is only an example, and the embodiment of the disclosure is not limited thereto. For example, the control utterance may be obtained together with the wake-up utterance.

According to various embodiments, the listener 510 may generate a control message (or a control command) based on at least part of the obtained utterance (or utterance data). According to an embodiment, the listener 510 may transmit the generated control message to a target executor, which will perform an operation according to an utterance, from among a plurality of executors 521, 522, 523, 524, and 525 by using the first server 503. According to an embodiment, the control message may be generated based on the processing result for utterance data.

According to an embodiment, the processing of the utterance data may be performed through natural language processing by the listener 510 and/or natural language processing by the first server 503. For example, the listener 510 may process the utterance data by itself by using a voice processing module included in the listener 510.

According to an embodiment, the listener 510 may transmit the utterance data to the first server 503 and then may request the processing result of the utterance data. For example, the listener 510 may have first-level utterance data processing capability. For example, the listener 510 may include a first-level speech recognition module and a first-level NLU module. For example, the first server 503 may have utterance data processing capability having a second level higher than the first level. For example, the first server 503 may include a second-level speech recognition module and a second-level NLU module.

According to various embodiments, the plurality of executors 520 may include at least one of the smart phone 521, the computer 522 (e.g., a personal computer, a notebook PC, or the like), the television 523, the refrigerator 524, and the lighting device 525. The executors 520 may further include an air conditioner, a temperature control device, a surveillance device, a gas valve control device, and/or a door lock device.

According to an embodiment, each of the plurality of executors 520 may include a communication circuit. Accordingly, each of the plurality of executors 520 may establish communication with the first server 503 so as to transmit and receive various information by using a specified protocol (e.g., Bluetooth™, Wi-Fi, Zigbee, or the like). According to an embodiment, the plurality of executors 520 may transmit information (e.g., on/off information of a device) about operating states of the plurality of executors 520 to the listener 510 or the first server 503. According to an embodiment, the plurality of executors 520 may receive a control message (e.g., on/off control command of a device, another operation control command of a device, or the like) from the listener 510 or the first server 503 and may execute an operation corresponding to the control message. According to an embodiment, the plurality of executors 520 may transmit, to the listener 510 or the first server 503, the execution result of the operation corresponding to the control message.

According to an embodiment, the first server 503 may establish a session between the listener 510 and the plurality of executors 520 such that an operation according to the utterance obtained by the listener 510 is performed. For example, the session may mean a connection or binding state between the listener 510 and a target executor (e.g., at least one of executors 521, 522, 523, 524, or 525) until the target executor performs at least one operation in response to the utterance received by the listener 510. For example, the session may mean a logical connection or binding state between the at least one listener 510 and at least one of the plurality of executors 520, which is used to perform an operation corresponding to the utterance. For example, the first server 503 may establish a first channel for communication with the listener 510, and may establish a second channel for communication with at least one of the plurality of executors 520. For example, the first server 503 may establish a session between the listener 510 and the executor 520 by using first device information of the listener 510 received through the first channel and second device information of the plurality of executors 520 received through the second channel. For example, the first server 503 may control maintenance, termination, and reconnection of a session between the listener 510 and the plurality of executors 520. For example, the first server 503 may control the transmission and reception of information between the listener 510 and the plurality of executors 520, and the distribution of information between the listener 510 and the plurality of executors 520.

According to various embodiments, the first server 503 may establish a session between the single listener 510 and a single executor (e.g., 523). The disclosure is not limited thereto. For example, a session between the one listener 510 and a plurality of executors (e.g., 523 and 524) may be established, or a session between the plurality of listeners 510 and a single executor may be established. According to an embodiment, the first server 503 may establish a session between a single executor and each of a plurality of the listeners 510, and may integrate, maintain, or release the plurality of sessions thus generated. For example, in a state of establishing a first session between the listener 510 and an executor (e.g., one of executors 521, 522, 523, 524, and 525), the first server 503 may establish a second session between an additional listener and the executor. For example, each of listeners different from one another may establish a single session with the same executor. For example, the first server 503 may integrate single sessions (e.g., the first session and the second session) based on a specified condition and then may establish the integrated session; alternatively, the first server 503 may separate or release at least one single session from the integrated session. According to various embodiments, the specified condition may include at least part of an attribute (e.g., capability of a listener) of a listener, a state (e.g., an on/off state of a display, a network connection state, a lock state, and/or a power saving state) of a listener, information (e.g., content of an utterance, continuity of an utterance, and/or a time of an utterance) associated with an utterance, and information (e.g., a session lock time and/or a session retention reference value) of a single session. According to an embodiment, the session lock time may be a reference time set to maintain a session after the session is established. For example, the session lock time may be set to a different value depending on each device (e.g., the listener 510). According to an embodiment, the session retention reference value may be a value set for session management, and may be set to, for example, half of the session lock time.

According to an embodiment, the listener 510 may receive an utterance to be performed by the plurality of executors 520. Herein, when an utterance of the user 501 indicates a plurality of target executors, a session between the single listener 510 and a plurality of executors (e.g., the TV 523 and the refrigerator 524) may be established.

For example, when an utterance of “play ‘infinite challenge’ on the TV 523 and tell me weather information through the refrigerator 524” is received through the listener 510 (e.g., a speaker), the TV 523 and the refrigerator 524 may perform an operation on the utterance of the user 501. That is, the first server 503 may establish a session between the single listener 510 and a plurality of executors (e.g., the TV 523 and the refrigerator 524).

According to an embodiment, to establish a session between the listener 510 and the plurality of executors 520, the listener 510 may transmit first device information about the listener 510 to the second server 505. Each of the plurality of executors 520 may transmit second device information about each of the plurality of executors 520 to the second server 505. The second server 505 may store and manage the first device information and the second device information, which are used to establish a session between the listener 510 and the plurality of executors 520. The second server 505 may provide the first device information about the listener 510 and the second device information about each of the plurality of executors 520 to the first server 503. The first server 503 and the second server 505 may be arranged in different configurations. The disclosure is not limited thereto. For example, the first server 503 and the second server 505 may be arranged in the same configuration. While FIG. 5 illustrates that the first server 503 and the second server 505 are separately implemented, the first server 503 and the second server 505 may be integrated into a single server.

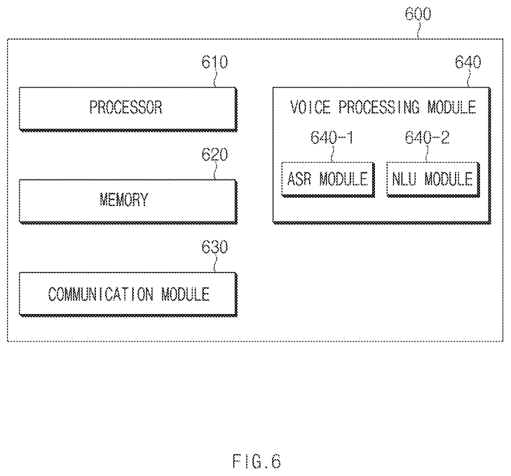

FIG. 6 is a view illustrating a configuration of an electronic device, according to an embodiment.

According to an embodiment, an electronic device (e.g., a listener) 600 (e.g., the electronic device 101 of FIG. 1, the user terminal 300 of FIG. 2, or the listener 510 of FIG. 5) may include a processor 610, a memory 620, a communication module 630, and a voice processing module 640.

According to various embodiments, under the control of the processor 610 (e.g., the processor 120 of FIG. 1 or the processor 360 of FIG. 2), an utterance that is received may be processed through the electronic device 600 and a first server (e.g., the first server 503 in FIG. 5) in response to receiving the utterance. According to an embodiment, the processor 610 may control the voice processing module 640 such that natural language processing is performed on utterance data received from a user (e.g., the user 501 in FIG. 5). For example, the processor 610 may control the voice processing module 640 to obtain at least one of the intent for an utterance of the user (e.g., the user 501 in FIG. 5), a domain for executing a task, and data (e.g., a slot or a task parameter) required to grasp the user's intent. For example, the processor 610 may control the communication module 630 to provide the received utterance to the first server such that the received utterance is processed through the first server.

According to various embodiments, the electronic device 600 may perform a function of a listener receiving the user's voice. The electronic device 600 may include a voice input device (e.g., a microphone) so as to receive the user's voice. For example, the electronic device 600 may provide a result of performing an operation according to the user's utterance. The electronic device 600 may include a sound output device (e.g., a speaker), a display, and one or more lamps so as to provide the result of performing an operation according to the utterance.

According to various embodiments, under the control of the processor 610, a control message (or a control command) may be generated based on one result among a first processing result of the utterance data performed through the electronic device 600 and a second processing result of the utterance data performed through the first server. According to an embodiment, the processor 610 may select the processing result to be used to generate a control message, based on pre-stored intent masking information. The intent masking information may be information indicating that an utterance processing target is specified for intent. For example, the processor 610 may identify intent by processing the received utterance, and then may determine whether an utterance associated with the identified intent is defined to be processed through the electronic device 600 or to be processed through the first server, based on the intent masking information,

According to another embodiment, the processor 610 may process the pre-stored intent masking information to be updated. According to an embodiment, under the control of the processor 610, the processing result of the received utterance may be provided to the first server. For example, the processor 610 may receive the intent masking information corresponding to the processing result by transmitting the processing result of the utterance data performed by the electronic device 600 (e.g., the voice processing module 640) to the first server. For example, the processor 610 may process the intent masking information stored in advance in the memory 620 so as to be updated, based on at least part of the intent masking information received from the first server.

According to various embodiments, the voice processing module 640 may grasp intent and/or domain for a user input by performing natural language processing on the utterance obtained from the user. For example, the voice processing module 640 may generate a natural language processing result of a user input, based on natural language understanding. According to an embodiment, the voice processing module 640 may include an ASR module 640-1, and a NLU module 640-2. According to various embodiments, the voice processing module 640 may further include a NLG module and a TTS module.

According to an embodiment, the ARS module 640-1 may generate text data expressing the received utterance in a specified language. The ARS module 640-1 may generate text data by using an acoustic model and a language model. The acoustic model may include information associated with phonation, and the language model may include unit phoneme information and information about a combination of unit phoneme information. For example, the ARS module 640-1 may convert a user utterance into text data by using the information associated with phonation and unit phoneme information.

According to an embodiment, the NLU module 640-2 may grasp the intent for a user input or may grasp a matching domain, by using a natural language processing model with respect to text data generated by the ARS module 640-1. The NLU module 640-2 may obtain a component (e.g., a slot and a task parameter) necessary to express the user's intent. For example, the NLU module 640-2 may process utterance data based on syntactic analysis and semantic analysis. The domain or intent corresponding to the utterance is determined based on the processing result, and the component necessary to express the user's intent may be obtained. According to an embodiment, the NLU module 640-2 may include a plurality of NLU modules. Each of a plurality of NLU modules may correspond to each of a plurality of executors (e.g., the plurality of executor 520 in FIG. 5). For example, each NLU module may grasp the intent for a user input or the matching domain with reference to a NLU database corresponding to each executor (e.g., the executor 521, 522, 523, 524, or 525 of FIG. 5).

According to an embodiment, the voice processing module 640 (e.g., an NLG module) may generate data, which is generated while natural language processing is performed, in a natural language form. The data generated in a natural language form may be the result of natural language understanding. For example, the NLG module may generate an execution result indicating whether a control operation corresponding to a control utterance has been performed by a plurality of executors, in a natural language form. According to an embodiment, the voice processing module 640 may be integrated with the processor 610. For example, the processor 610 may include the voice processing module 640; alternatively, the processor 610 may perform a function or operation of the voice processing module 640.

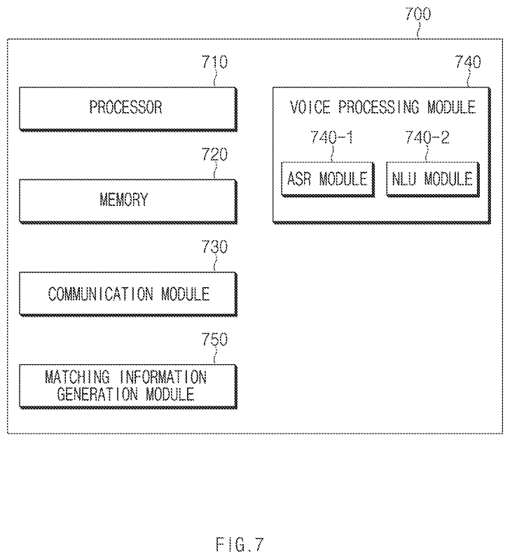

FIG. 7 is a view illustrating a configuration of an electronic device, according to an embodiment.

According to an embodiment, at least part of components of an electronic device (e.g., a first server) 700 (e.g., the electronic device 101 of FIG. 1, the intelligent server 200 of FIG. 2, or the first server 503 of FIG. 5) may correspond to at least part of components of a listener (e.g., the listener 510 of FIG. 5 or the electronic device 600 of FIG. 6). For example, the electronic device 700 may include a processor 710 (e.g., the processor 120 in FIG. 1), a memory 720, a communication module 730, and a voice processing module 740, and may additionally or selectively further include a matching information generation module 750. Accordingly, a detailed description of components of the electronic device 700 corresponding to components of the listener may be omitted. According to various embodiments, an intelligent assistance system (e.g., the intelligent assistance system 500 in FIG. 5) may include the plurality of electronic devices 700 (e.g., the first server 503 or the second server 505 in FIG. 5) depending on the processing capacity for a user utterance.

According to various embodiments, the processor 710 of the electronic device 700 may control the voice processing module 740 such that utterance data received from the listener is processed. The processor 710 may provide a listener with a processing result of the utterance data. For example, the processing result may include at least one of intent for a user input, a domain for executing a task, and data (e.g., a slot or a task parameter) required to grasp the user's intent.

According to various embodiments, under the control of the processor 710 of the electronic device 700, intent masking information may be provided to the listener as a part of the processing result. As described above, the intent masking information may be information indicating that an utterance processing target is specified for intent. Furthermore, as will be described later, the intent masking information may be generated by the matching information generation module 750.

According to various embodiments, similarly to the voice processing module 640 of a listener, the voice processing module 740 of the electronic device 700 may include an ASR module 740-1 and an NLU module 740-2. According to an embodiment, the voice processing module 740 of the electronic device 700 may have processing capability higher than utterance data processing capability of the listener. For example, the processing result of the utterance (or utterance data), which is performed by the voice processing module 740 of the electronic device 700, may be more accurate than the utterance processing result performed by the voice processing module (e.g., the voice processing module 640 of FIG. 6) of the listener.

According to various embodiments, the matching information generation module 750 of the electronic device 700 may generate the intent masking information based on the processing result performed by the listener (e.g., the voice processing module of the listener). The intent masking information may be associated with a matching rate between a first processing result of utterance data performed by the listener (e.g., the voice processing module 640 of a listener) and a second processing result of utterance data performed by the electronic device 700 (e.g., the voice processing module 740). According to an embodiment, the electronic device 700 may receive the first processing result from the listener. The matching information generation module 750 may identify the matching rate of the first processing result by comparing the received first processing result with the second processing result performed by the electronic device 700. Moreover, the matching information generation module 750 may generate the intent masking information indicating that one of the listener or the electronic device 700 is specified as the processing target of the received utterance, based on the identified matching rate.

According to an embodiment, the voice processing module 740 and/or the matching information generation module 750 may be integrated with the processor 710. For example, the processor 710 may include the voice processing module 740 and/or the matching information generation module 750; alternatively, the processor 710 may perform a function or step of the voice processing module 740 and/or the matching information generation module 750.

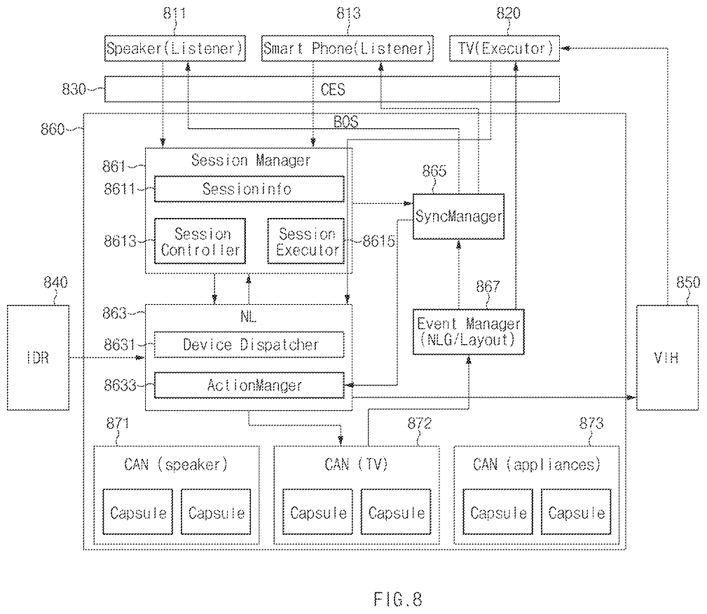

FIG. 8 is a diagram illustrating an operation of an intelligent assistance system, according to an embodiment.

According to an embodiment, an intelligent assistance system may include at least one listener (811, 813) (e.g., the listener 510 of FIG. 5 and/or the electronic device 600 of FIG. 6), at least one executor 820 (e.g., the executor 520 in FIG. 5), and at least one server 860 (e.g., the first server 503 or the second server 505 in FIG. 5) (e.g., Bixby operating service (BOS)). According to an embodiment, the intelligent assistance system may further include a capsule execution service (CES) 830, an intelligent device resolver (IDR) module 840, or a voice intent handler (VIH) module 850. According to various embodiments, at least part of the CES 830, the BOS 860, the IDR 840, and the VIH 850 may be integrated into one server; alternatively, each of the CES 830, the BOS 860, the IDR 840, and the VIH 850 may be implemented with an independent server.

According to an embodiment, the listener 811, 813 and the BOS server 860 may transmit and receive data through the CES 830. The executor 820 and the BOS server 860 may transmit and receive data through the CES 830. According to an embodiment, the CES 830 may start services for processing an utterance, which is received through the listener (811, 813) and which is entered by a user, and may mediate the result of processing an utterance through the BOS server 860. For example, the CES 830 may execute an ASR service for receiving the voice uttered by the user, may transmit natural language to the BOS 860, and may deliver, to the listener 811, 813 or the executor 820, the result of processing an utterance (e.g., a TTS or a message) in the BOS server 860. According to an embodiment, the CES 830 may support the management of a first channel for connecting the listener 811, 813 to the BOS server 860, and the management of a second channel for connecting the executor 820 to the BOS server 860. For example, the CES 830 may notify the listener 811, 813 of the BOS server 860 to be connected among a plurality of servers, and may notify the executor 820 of the BOS server 860 to be connected among the plurality of servers. For example, the CES 830 may notify the listener 811, 813 and the executor 820 of a server, to which the listener 811, 813 or the executor 820 is to be connected, from among the plurality of servers. According to an embodiment, the utterance recognized by the listener 811, 813 may be delivered to the BOS server 860 through the CES 830, and a session between the listener 811, 813 and the executor 820 may be established based on a conversation ID. According to an embodiment, the conversation ID may be an identification value assigned to each conversation (e.g., at least one utterance). For example, in the case of a plurality of utterances that are continuous, the same conversation ID may be assigned.

According to an embodiment, the BOS server 860 may deliver a user utterance to a capsule of a CAN 871, 872, 873, and may process the utterance. According to various embodiments, the server 860 may include a session manager 861, an NLU module NL 863, a sync manager 865, an event manager 867, and the at least one CAN 871, 872, 873. According to an embodiment, the at least one CAN 871, 872, 873 may correspond to a different executor (e.g., a speaker, a TV, and an appliance). According to an embodiment, at least part of components (e.g., the session manager 861, the NLU module NL 863, the sync manager 865, or the event manager 867) of the BOS server 860 may be implemented with one processor.

According to an embodiment, when the plurality of listeners 811, 813 request the utterance processing of the same executor 820, the session manager 861 may manage a single session or an integrated session between the executor 820 and the plurality of listeners 811, 813 based on the session management policy. According to an embodiment, the session manager 861 may include a session information module (session info) 8611, a session controller 8613, and a session execution module (session executor) 8615. According to an embodiment, the session manager 861 may update session-related information stored in the session information module 8611 based on the information delivered from the listener 811, 813, the executor 820, and/or the NLU module NL 863. For example, the session manager 861 may update session connection information between the listeners 811, 813 and the executor 820, which is stored in the session information module 8611, and/or state information of the executor 820 based on the delivered information.

According to an embodiment, the session information module 8611 may store connection information between the listeners 811, 813 and the executor 820. For example, the session information module 8611 may store listener-related information (e.g., the type, name, state, and/or unique information (e.g., serial number or international mobile equipment identity (IMEI)) of the listener 811, 813), executor-related information (e.g., the type, name, state, and/or the unique information (e.g., serial number or IMEI) of the executor 820), a session lock time, a session creation time, a session expiration time, a time at which a last utterance is processed in a session, and/or utterance information in a session.

According to an embodiment, the session controller 8613 may determine a method of processing each session based on information stored in the session information module 8611. For example, on a basis of the information stored in the session information module 8611, the session controller 8613 may establish or release a session or may determine whether to integrate sessions (e.g., integration or separation of sessions). For example, when the session controller 8613 establishes a new session based on the session management policy, the session controller 8613 may determine to release an existing session or to integrate the existing session with a new session. For example, the session controller 8613 may determine to separate the integrated session into a plurality of sessions based on the session management policy. For example, the session controller 8613 may establish the session management policy based on at least one of the listener's user account information, listener-related information, executor-related information, pre-established session-related information (e.g., a session lock time and/or a session retention reference value), and an utterance received through the listener. For example, the session lock time may be a time set to maintain a session when a session is established. For example, when the listener receives a new utterance, the session lock time may be initialized (reset) to maintain a state of the session from a point in time when an utterance is received.

According to an embodiment, the session execution module 8615 may actually establish, release, integrate, or separate a session between the listeners 811, 813 and the executor 820 depending on the processing method determined by the session controller 8613. According to an embodiment, the session execution module 8615 may update the session information module 8611 based on the session processing method (e.g., the establishing, releasing, integrating, or separating a session) determined by the session controller 8613. According to an embodiment, the session execution module 8615 may assign a conversation ID to the newly-delivered utterance and may assign a session ID to a session that is newly generated or changed. For example, the session execution module 8615 may store a conversation ID and a session ID in the session information module 8611. According to an embodiment, the session execution module 8615 may temporarily store information to be at least temporarily stored in the session information module 8611 before the session information module 8611 is updated. According to an embodiment, after an operation corresponding to an utterance is performed by the executor 820, the session execution module 8615 may deliver temporarily-stored information to the sync manager 865 and may allow information suitable for session management policy to be delivered to each listener 811, 813.

According to an embodiment, the NLU module 863 may analyze the utterance. According to an embodiment, the NLU module 863 may determine whether the received utterance is an utterance in a multi device experience (MDE) environment, based on a device list received through the IDR module 840. According to an embodiment, the IDR module 840 may find at least one device, which is suitable to process a user utterance in consideration of the state and/or location of a device, from among devices (e.g., IoT devices) registered in the user's account. According to an embodiment, the IDR module 840 may provide the NLU module 863 with a list of at least one device suitable to process a user utterance. According to an embodiment, when the received utterance is an utterance in the MDE environment, the NLU module 863 may allow the session manager 861 to update session-related information. For example, the NLU module 863 may provide the session manager 861 with information obtained by analyzing an utterance, and the session manager 861 may update session-related information based on the information. According to an embodiment, the NLU module 863 may provide the VIH module 850 with the information obtained by analyzing the utterance. According to an embodiment, the VIH module 850 may activate (e.g., wake up) a device (the executor 820), which will perform an operation corresponding to an utterance, based on the received information. For example, the VIH module 850 may recognize the executor 820, which will perform an operation corresponding to the utterance, from among a plurality of electronic devices, and may instruct the recognized executor 820 to perform an operation corresponding to the utterance. According to an embodiment, the VIH module 850 may perform a service for executing an IoT-related command recognized from the user's utterance. For example, when a user speaks to the intelligent assistance system to control an IoT device (e.g., the listener 811, 813 or the executor 820), a rule, or a scene, the NLU module 863 of the intelligent assistance system may analyze the intent of the user and may assign a tag to the parameters of the utterance. According to an embodiment, the intelligent assistance system may perform an operation according to the user's intent through the VIH module 850. According to an embodiment, the VIH module 850 may recognize a rule, a scene, or a target device, which matches the user's utterance (intent), from among devices registered in the user's account, and may transmit an IoT command (e.g., a command for performing an operation according to a user utterance) to a target device by using an IoT protocol.

According to an embodiment, the NLU module NL 863 may include a device dispatcher detector 8631 and an action manager 8633. According to an embodiment, the device dispatcher detector 8631 may analyze an utterance, and then may recognize whether the utterance includes a device dispatcher. According to an embodiment, the action manager 8633 may store information of the utterance requested by the listener (e.g., speaker (811)) and information of an operation actually performed by the executor 820. In the case where the action manager 8633 receives a request from a new listener (e.g., the smart phone 813), when operations corresponding to utterances received from each listener (811, 813) are the same as one another, the same operation may be prevented from being redundantly processed. According to an embodiment, the action manager 8633 may receive a result of processing the utterance from the sync manager 865. According to an embodiment, the action manager 8633 may store information (e.g., context information of the executor 820) associated with the executor 820 and information about utterances requested by each listener 811, 813. For example, the action manager 8633 may store and manage the information associated with the executor 820 and the information about the utterances, in a table. According to an embodiment, when the utterance processing operation for the same executor 820 is delivered from a new listener (e.g., the smart phone 813) (i.e., when the corresponding executor 820 is already activated by the utterance received from another listener (e.g., the speaker 811)), the action manager 8633 may directly make a request for the utterance processing to the CAN (e.g., the CAN of the TV 872) corresponding to the executor 820 based on information associated with the executor 820 without calling the VIH module 850. For example, the executor-related information (e.g., context information of the executor 820) may include at least one of unique information (e.g., ID or IMEI) of the executor 820, state information of the executor 820, and operation execution information corresponding to an utterance for the respective executor 820. For example, when the executor 820 is already activated and then is performing an operation corresponding to the previous utterance, the action manager 8633 may prevent the VIH module 850 from repeatedly processing an operation for unnecessarily activating the executor 820, and from not repeatedly performing an operation of requesting utterance processing, by not calling the VIH module 850. According to an embodiment, when there is information about a session through which the listener (e.g., the speaker 811) and the executor 820 are connected, the action manager 8633 may determine whether the same utterance processing request is present, before delivering an utterance processing request for the same executor 820 received from a new listener (e.g., the smart phone 813) to the executor 820. For example, when there is a session between the first listener 811 and the executor 820, which is used to process an operation corresponding to a first utterance received from a first listener (e.g., the speaker 811) and the action manager 8633 receives a request to process an operation corresponding to a second utterance for the same executor 820 from a second listener (e.g., the smart phone 813), the action manager 8633 may determine whether the operation corresponding to the first utterance is the same as the operation corresponding to the second utterance. For example, when the operation corresponding to the first utterance is the same as the operation corresponding to the second utterance, the action manager 8633 may not deliver, to the executor 820, a request for performing the operation corresponding to the second utterance. For example, when the action manager 8633 receives an utterance for requesting the same operation from each of the different listeners 811, 813, the action manager 8633 may not deliver, to the executor 820, the request for a redundant operation.

According to an embodiment, the VIH module 850 may receive an utterance processing request from the NLU module 863, and may request the executor 820 corresponding to the utterance to perform an operation corresponding to the utterance. For example, the VIH module 850 may activate the executor 820 and may transmit information associated with an utterance to the executor 820.

According to an embodiment, when the executor 820 receives the information related to the utterance from the VIH module 850, the executor 820 may transmit context information associated with a device (the executor 820) to the NLU module 863. According to an embodiment, the NLU module 863 may deliver, to the CAN (e.g., 872) corresponding to the executor 820, an utterance delivered from the listeners 811, 813 and/or the context information received from the executor 820. For example, the executor 820 activated by the VIH module 850 may transmit, to the CES 830 and/or the BOS server 860, information (e.g., context information of the executor 820) associated with a current device.

According to an embodiment, each CAN (871, 872, 873) may correspond to at least one of listeners 811 and 813 and the executor 820. According to an embodiment, each CAN (871, 872, 873) may include at least one capsule. According to an embodiment, the operation corresponding to the corresponding utterance may be processed in the capsule of the CAN corresponding to the executor 820 based on the utterance delivered from the listener 811, 813 and the context information delivered from the executor 820.

According to an embodiment, a result processed in the capsule may be delivered to the event manager 867. According to an embodiment, the event manager 867 may deliver the result processed in the capsule to the corresponding executor 820 or the sync manager 865. According to an embodiment, after an operation according to an utterance is performed, the event manager 867 may allow the result of utterance to be transmitted to the listener 811, 813 and/or the executor 820. According to an embodiment, the event manager 867 may determine a channel through which the execution result of an utterance is transmitted to the listener (811, 813) and/or the executor 820. According to an embodiment, the event manager 867 may determine whether to transmit the execution result of an utterance as it is without processing the execution result, or to transmit the execution result of an utterance after modifying the execution result depending on a UI form of the listener (811, 813) and/or the executor 820. According to an embodiment, when the execution result of an utterance needs to be modified, the event manager 867 may modify the execution result of utterance depending on the UI form of listener (811, 813 and/or the executor 820, and may transmit the modified execution result of the utterance to the listeners 811, 813 and/or the executor 820.

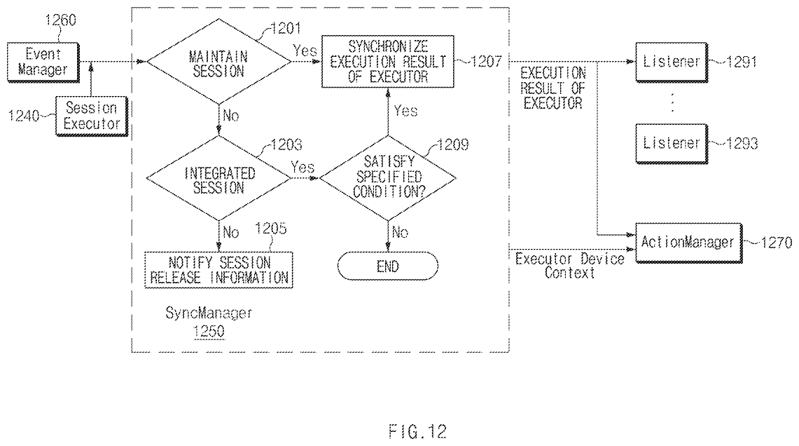

According to an embodiment, the sync manager 865 may provide each listener 811, 813 with the result processed by the executor 820. For example, the sync manager 865 may synchronize the result processed by the executor 820 in each listener 811, 813 and/or the executor 820. According to an embodiment, the sync manager 865 may provide (synchronize) the result of processing an utterance to the listeners 811, 813 connected to the same session. According to an embodiment, the sync manager 865 may receive session-related information from the session execution module 8615, and may provide appropriate information to each listener 811, 813 connected to the session based on information associated with the session. For example, the sync manager 865 may provide each listener 811, 813 with session information (e.g., release information of a session) and/or the execution result of the capsule processed by the executor 820. An example of an operation of the sync manager 865 will be described in more detail with reference to FIG. 12 below.

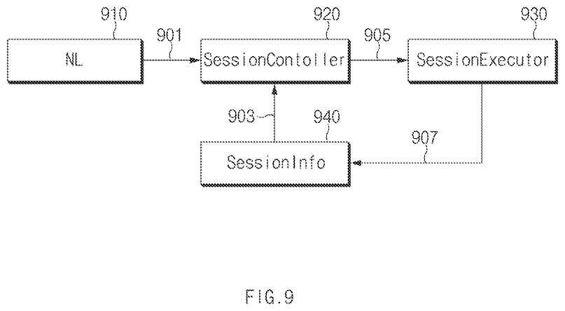

FIG. 9 is a diagram illustrating a session management operation of an intelligent assistance system, according to an embodiment.

According to an embodiment, in operation 901, an NLU module (NL) 910 (e.g., the NLU module 863 of FIG. 8) may analyze an utterance delivered from a listener. For example, the NLU module 910 may determine whether the utterance is an utterance received in an MDE environment. According to an embodiment, when recognizing the utterance in the MDE environment, the NLU module 910 may deliver information associated with an utterance to a session controller 920 (e.g., the session controller 8613 of FIG. 8).

According to an embodiment, in operation 903, the session controller 920 may receive session-related information from a session information module (session info) 940 (e.g., the session information module 8611 of FIG. 8). According to an embodiment, the session controller 920 may determine whether an executor that will perform an operation corresponding to the newly-received utterance is currently establishing a session with another listener, based on the session-related information. According to an embodiment, when an existing session associated with the same executor is present, the session information module 940 may provide information associated with the corresponding session to the session controller 920. According to an embodiment, when there is no existing session associated with the same executor, the session information module 940 may not provide the session-related information to the session controller 920.

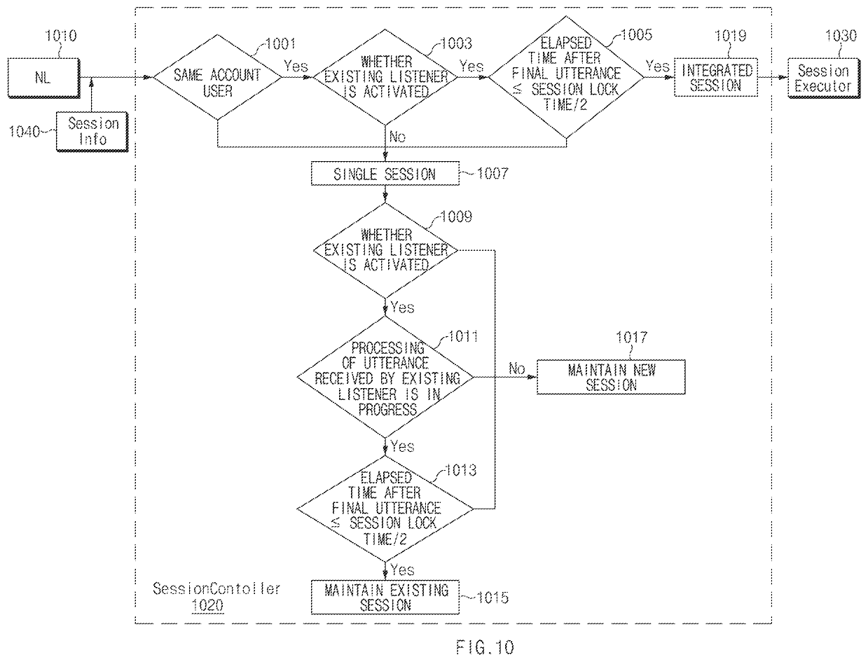

According to an embodiment, in operation 905, the session controller 920 may determine whether to generate, release, integrate, or separate a session depending on a specified criterion, based on the session-related information. According to an embodiment, the session controller 920 may generate, release, integrate, or separate a session based on at least one of a user account, a listener's state, an utterance, and session-related information (e.g., a session lock time and/or a session retention reference value). According to an embodiment, the session controller 920 may manage a session based on a session management policy. For example, the session controller 920 may establish the session management policy based on at least one of a user account, a listener's state, an utterance, and session-related information (e.g., a session lock time and/or a session retention reference value). An example of an operation in which the session controller 920 processes a session will be described in more detail with reference to FIG. 10 below.

According to an embodiment, the session controller 920 may deliver the determined session management information (e.g., the session management policy) to a session execution module (session executor) 930 (e.g., the session execution module 8615).

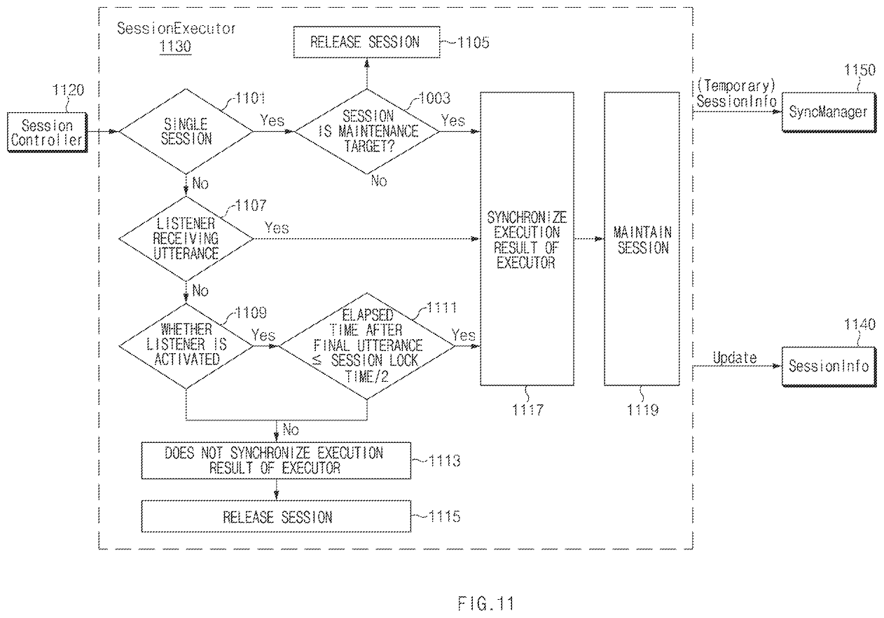

According to an embodiment, in operation 907, the session execution module 930 may actually generate, maintain, integrate, or release a session based on the session management information received from the session controller 920. According to an embodiment, the session execution module 930 may at least temporarily store the session management information received from the session controller 920. According to an embodiment, after an operation corresponding to an utterance is performed by an executor, the session execution module 930 may transmit the temporarily-stored session management information to the session information module 940, and then may allow information, which is stored in the session information module 940, to be updated. An example of an operation in which the session execution module 930 processes a session will be described in more detail with reference to FIG. 11 below.

FIG. 10 is a flowchart illustrating a session management operation of an intelligent assistance system, according to an embodiment.

According to an embodiment, a session controller 1020 (e.g., the session controller 8613 of FIG. 8 and/or the session controller 920 of FIG. 9) may determine whether to generate, release, integrate, or separate a session based on an utterance delivered from an NLU module (NL) 1010 (e.g., the NLU module 863 of FIG. 8 and/or the NLU module 910 of FIG. 9) and information delivered from a session manager (e.g., the session information module (session info) 1040 (e.g., the session information module 8611 of FIG. 8 and/or the session information module 940 of FIG. 9)), and then may provide a session execution module 1030 (e.g., the session execution module 8615 of FIG. 8 and/or the session execution module 930 of FIG. 9) with information for managing the session. According to an embodiment, when an utterance is delivered from a new second listener in a state where a first session between the first listener and an executor is established, the session controller 1020 may determine whether a device, which will perform an operation corresponding to an utterance, is the same as an executor of the first session. According to an embodiment, the session controller 1020 may determine whether to establish a second session between a second listener and the executor independently of the first session; alternatively, the session controller 1020 may determine whether to establish an integrated session by integrating the first session and the second session.

According to an embodiment, in operation 1001, the session controller 1020 may determine whether the first listener and the second listener are devices having the same user account. According to an embodiment, when the second listener receiving a new utterance is a device having the same user account as the first listener, the session controller 1020 may perform operation 1003. When the second listener is a device having a user account different from a user account of the first listener, the session controller 1020 may perform operation 1007.

According to an embodiment, in operation 1003, the session controller 1020 may determine whether the first listener is activated. For example, the session controller 1020 may determine whether a display of the first listener is turned on or whether the first listener is connected to a network. For example, the session controller 1020 may determine whether the first listener is in a session lock state. For example, the session lock state may be a state (e.g., a state before a session lock time elapses after an utterance is received) set to maintain a pre-established session. According to an embodiment, when the first listener is activated, the session controller 1020 may perform operation 1005. When the first listener is not activated, the session controller 1020 may perform operation 1007.

According to an embodiment, in operation 1005, the session controller 1020 may determine whether the elapsed time after the first listener has recently received an utterance is not greater than a session retention reference value (e.g., half of the session lock time). According to an embodiment, when the elapsed time after the utterance is received is not greater than the session retention reference value, the session controller 1020 may perform operation 1019. When the elapsed time exceeds the session retention reference value, the session controller 1020 may perform operation 1007.

According to an embodiment, operation 1001 to operation 1005 is an example, and some operations may be omitted or the order of the operations may be changed.

According to an embodiment, in operation 1007, the session controller 1020 may determine to establish a second session between the second listener and the executor independently of the first session. According to an embodiment, when the session controller 1020 determines to establish an independent second session, the session controller 1020 may determine whether to maintain or release each of the existing first session and the new second session.

According to an embodiment, in operation 1009, the session controller 1020 may determine whether the first listener is activated. According to an embodiment, when the first listener is activated, the session controller 1020 may perform operation 1011. When the first listener is not activated, the session controller 1020 may perform operation 1017.

According to an embodiment, when processing of an utterance received by the first listener is in progress in operation 1011, the session controller 1020 may perform operation 1013. When the processing of the utterance is not in progress in operation 1011, the session controller 1020 may perform operation 1017. For example, when the utterance received by the first listener corresponds to a capsule lock situation or a prompt lock situation, the session controller 1020 may perform operation 1013. According to an embodiment, the capsule lock situation may mean a situation set to maintain the execution of the corresponding operation in the capsule of CAN corresponding to an executor with respect to the utterance received from the first listener. For example, the capsule lock situation may mean a situation set to have a priority such that the currently-activated capsule performs an additional utterance of a user. For example, when the user enters an utterance of “today's weather”, a weather-related capsule may process the corresponding utterance. For example, when the weather-related capsule is maintained in a capsule lock state during a specified time, the utterance entered additionally by the user may be directly delivered to the weather-related capsule, which has priority over another capsule, and then may be processed. According to an embodiment, the capsule lock situation may include a prompt lock situation and a result lock situation. According to an embodiment, the prompt lock situation may mean a situation set such that the first listener counts a time from a point in time when an utterance is obtained, and maintains a session to receive additional information associated with an utterance during a specified time (e.g., a time to wait for an additional input) after the utterance is obtained. For example, the prompt lock situation may be performed when an additional information input (e.g., an additional utterance) is required to finally process the user's root utterance. For example, when the user utters “add schedule”, the prompt lock situation may be set for a calendar (schedule)-related capsule to receive additional information such as an event title and date. According to an embodiment, the result lock situation may mean a lock situation in which the capsule performs a capsule lock by itself to have the priority of the user's additional utterances when an additional utterance input of the user is expected after the user's root utterance is completely processed.

According to an embodiment, when the elapsed time after the first listener receives an utterance is not greater than half of the session lock time in operation 1013, the session controller 1020 may perform operation 1015. When the elapsed time exceeds half of the session lock time, the session controller 1020 may perform operation 1017.

According to an embodiment, in operation 1015, the session controller 1020 may determine to maintain the existing first session. According to an embodiment, the session controller 1020 may determine not to establish the second session or may determine to release the second session.

According to an embodiment, in operation 1017, the session controller 1020 may determine to release the existing first session and to maintain the new second session.

According to an embodiment, operation 1009 to operation 1013 is an example, and some operations may be omitted or the order of the operations may be changed.

According to an embodiment, in operation 1019, the session controller 1020 may determine to establish an integrated session by integrating the first session between the first listener and the executor and the second session between the second listener and the executor. According to an embodiment, when the integrated session is established, information of the new second session may be managed by integrating the information with the ID of the existing first session. According to an embodiment, when a new session (e.g., the second session) is integrated into an existing session (e.g., the first session), the session lock time of the integrated session (e.g., the first session) may be updated (reset). According to an embodiment, when a new second session is added to the existing integrated session, the session controller 1020 may check states of all listeners associated with the existing integrated session, and then may determine to separate the session, which is associated with a listener that does not satisfy a specified condition, from the integrated session. According to an embodiment, when some sessions are separated from the integrated session, a point in time when the first session in the integrated session is established may be replaced with a point in time when the oldest individual session from among the remaining sessions in the integrated session is established.

According to an embodiment, the session controller 1020 may provide the determined session management information to the session execution module 1030.

FIG. 11 is a diagram illustrating a session management operation of an intelligent assistance system, according to an embodiment.

According to an embodiment, a session execution module 1130 (e.g., the session execution module 8615 of FIG. 8, the session execution module 930 of FIG. 9, and/or the session execution module 1030 of FIG. 10) may actually establish, release, integrate, and/or separate a session based on the session management information received from a session controller 1120 (e.g., the session controller 8613 of FIG. 8, the session controller 920 of FIG. 9, and/or the session controller 1020 of FIG. 10). According to an embodiment, when there is a change in a session (e.g., the establishment, release, integration, and/or separation of a session), the session execution module 1130 may provide session-related information according to the change in a session to a sync manager 1150 (e.g., the sync manager 865 of FIG. 8) and/or a session information module 1140 (e.g., the session information module 8611 of FIG. 8, the session information module 940 of FIG. 9, and/or the session information module 1040 of FIG. 10).

According to an embodiment, in operation 1101, the session execution module 1130 may determine whether the currently-established session is a single session or an integrated session. According to an embodiment, when the session is a single session, the session execution module 1130 may perform operation 1103. When the session is an integrated session, the session execution module 1130 may perform operation 1107.

According to an embodiment, in operation 1103, the session execution module 1130 may determine whether the corresponding session is a maintenance target. For example, the session execution module 1130 may determine whether each single session is a session to be maintained or a session to be released (terminated). According to an embodiment, when the corresponding session is the maintenance target, the session execution module 1130 may perform operation 1117. When the session is not the maintenance target, the session execution module 1130 may perform operation 1105.

According to an embodiment, in operation 1105, the session execution module 1130 may release the session. For example, the session execution module 1130 may release a single session that is not the maintenance target. For example, when there are a first session between a first listener and an executor and a second session between a second listener and the executor, the session execution module 1130 may release an unnecessary session among the first session and the second session. For example, when the first listener of the first session is activated (e.g., a display-on state or a network connection state) and an elapsed time after an utterance is finally received by the first listener in the first session is not greater than half of the session lock time, the session execution module 1130 may maintain the first session, and may release the second session between the second listener and the executor. Alternatively, when the first listener is not activated, or when the elapsed time after the utterance is finally received by the first listener in the first session exceeds half of the session lock time, the session execution module 1130 may release the first session and may maintain the second session.

According to an embodiment, in operation 1107, the session execution module 1130 may determine whether a listener included in the integrated session is a listener receiving the utterance being processed. According to an embodiment, when a listener is the listener receiving the utterance being processed, the session execution module 1130 may perform operation 1117. When the listener is not the listener receiving the utterance being processed, the session execution module 1130 may perform operation 1109.

According to an embodiment, in operation 1109, the session execution module 1130 may determine whether the listener is activated. According to an embodiment, when the listener is activated, the session execution module 1130 may perform operation 1111. When the listener is not activated, the session execution module 1130 may perform operation 1113.

According to an embodiment, in operation 1111, the session execution module 1130 may determine whether an elapsed time after the first listener has received a final utterance is not greater than a session retention reference value (e.g., half of the session lock time). According to an embodiment, when the elapsed time after an utterance is received is not greater than half of the session lock time, the session execution module 1130 may perform operation 1117. When the elapsed time after an utterance is received exceeds half of the session lock time, the session execution module 1130 may perform operation 1113.

According to an embodiment, in operation 1113, the session execution module 1130 may not synchronize an operation execution result corresponding to an utterance of the executor. For example, the session execution module 1130 may not provide the corresponding listener with the operation execution result corresponding to the utterance of the executor.

According to an embodiment, in operation 1115, the session execution module 1130 may release a session corresponding to the listener. For example, when the executor performs an operation corresponding to the utterance received from the listener, the session execution module 1130 may release the session corresponding to the listener.

According to an embodiment, in operation 1117, the session execution module 1130 may synchronize the operation execution result corresponding to the utterance of the executor. For example, the session execution module 1130 may provide the corresponding listener with the operation execution result corresponding to the utterance of the executor. According to an embodiment, the session execution module 1130 may temporarily store session-related information delivered from the session controller 1120, and then may transmit the session-related information to the sync manager 1150. After the operation corresponding to the utterance is performed by the executor, the session execution module 1130 may update the session-related information to the session information module 1140. For example, because the sync manager 1150 needs to distinguish between a listener, which will receive an execution result (e.g., a result of performing an operation corresponding to an utterance in an executor) of a capsule, and a listener, which will receive a session processing result (e.g., the establishment, release, integration, and/or separation of a session), and then delivers the corresponding information, when the sync manager 1150 delivers information to each session, the session execution module 1130 may synchronize (provide) related information after the utterance is processed.

According to an embodiment, in operation 1119, the session execution module 1130 may maintain a session for a listener that synchronizes (provides) the operation execution result corresponding to the utterance.

FIG. 12 is a diagram for describing a session management operation of an intelligent assistance system, according to an embodiment. According to an embodiment, a sync manager 1250 (e.g., the sync manager 865 of FIG. 8 and/or the sync manager 1150 of FIG. 11) may receive a result processed in the capsule from an event manager 1260 (e.g., the event manager 867 in FIG. 8). According to an embodiment, the sync manager 1250 may receive session-related information between each listener (1291, 1293) and an executor from a session execution module 1240 (e.g., the session execution module 8615 of FIG. 8, the session execution module 930 of FIG. 9, the session execution module 1030 of FIG. 10, and/or the session execution module 1130 of FIG. 11). According to an embodiment, the sync manager 1250 may provide information corresponding to each listener (1291, 1293) based on the received session-related information.

According to an embodiment, in operation 1201, the sync manager 1250 may determine whether a session of the listener (1291, 1293) connected to an executor is maintained or released. According to an embodiment, when the session is maintained, the sync manager 1250 may perform operation 1207. When the session is released, the sync manager 1250 may perform operation 1203.

According to an embodiment, in operation 1203, the sync manager 1250 may determine whether the executor is connected to an integrated session. According to an embodiment, when the executor is connected to the integrated session, the sync manager 1250 may perform operation 1209. When the executor is not connected to the integrated session, the sync manager 1250 may perform operation 1205.

According to an embodiment, in operation 1205, the sync manager 1250 may provide session release information. For example, the sync manager 1250 may notify the listener (1291, 1293), which satisfies a condition that a session is released or a new session request is rejected, of a session release result.

According to an embodiment, in operation 1207, the sync manager 1250 may synchronize the operation execution result corresponding to an utterance of an executor with the corresponding listener (1291, 1293). For example, the sync manager 1250 may provide the operation execution result corresponding to the utterance to the listener (1291, 1293) which satisfies a condition that the session is maintained.

According to an embodiment, in operation 1209, the sync manager 1250 may determine whether the listener (1291, 1293) satisfies a specified condition. For example, the sync manager 1250 may determine whether the listener (1291, 1293) included in the integrated session is a listener that requests for processing an utterance (i.e., whether the listener (1291, 1293) is a listener that has received the utterance being processed), whether the listener (1291, 1293) is activated, and/or whether the time elapsed after the final utterance is received is not greater than a session retention reference value (e.g., half of a session lock time). According to an embodiment, when the listener (1291, 1293) satisfies the specified condition, in operation 1207, the sync manager 1250 may provide the corresponding listener with a result in which the executor performs the operation corresponding to the utterance. According to an embodiment, when the listener (1291, 1293) does not satisfy the specified condition, the sync manager 1250 may not provide the session release result to the corresponding listener.

According to an embodiment, the sync manager 1250 may deliver, to each listener (1291, 1293) or an action manager 1270, the operation execution result corresponding to the utterance of the executor. For example, the sync manager 1250 may transmit executor-related information (e.g., executor context information) to the action manager 1270.

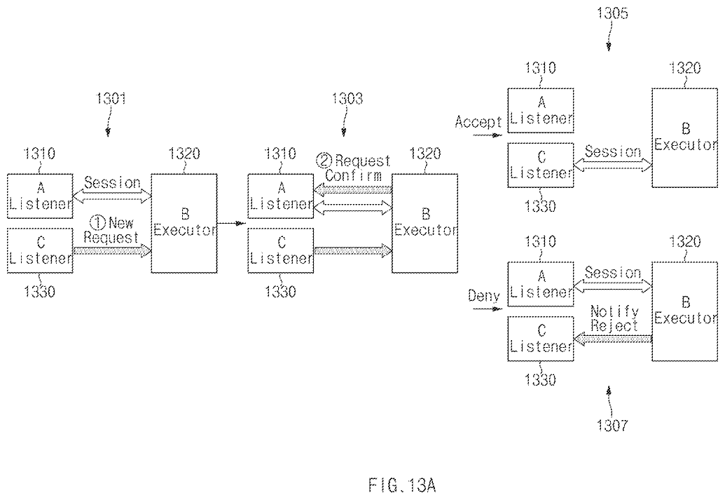

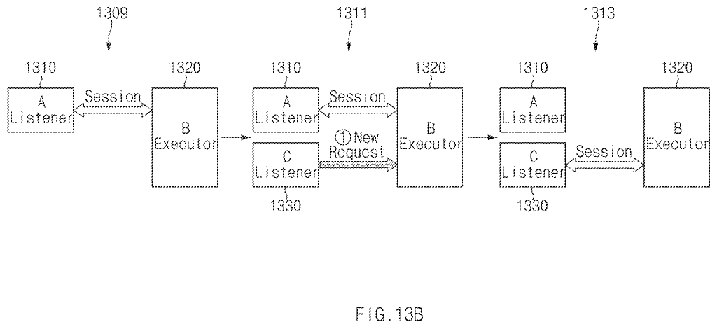

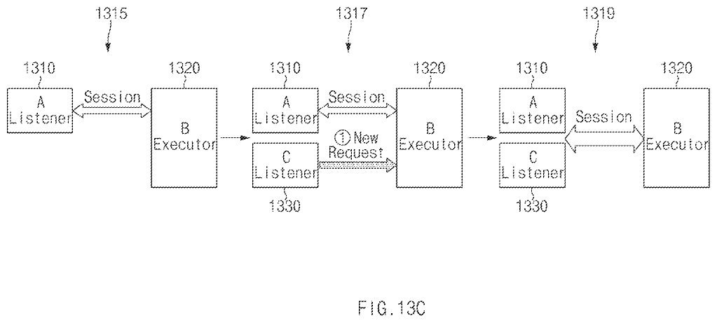

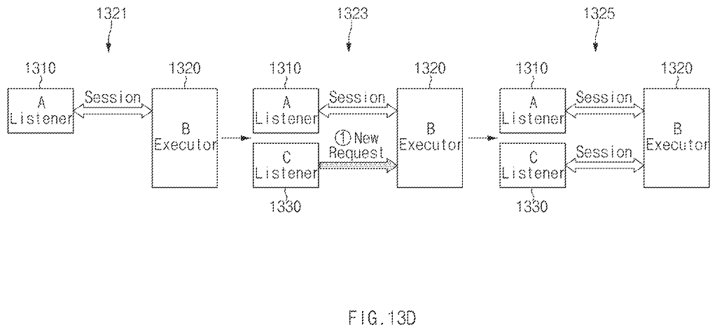

FIGS. 13A to 13D are diagrams illustrating examples of establishing a session, according to various embodiments. For example, FIGS. 13A to 13D illustrate an operation of establishing a session between a plurality of listeners 1310 and 1330 and an executor 1320 in an electronic device (e.g., a server (e.g., the server 860 in FIG. 8)), in an intelligent assistance system including the plurality of listeners (1310, 1330) and the executor 1320.

According to an embodiment, as in a case of FIGS. 13A to 13B, a method of establishing a session depending on user account information corresponding to each listener 1310 or 1330 may be different.

Referring to FIG. 13A, an operation at a point in time when a listener (e.g., the listener A 1310) establishing an existing session has priority over a listener (e.g., the listener C 1330) requesting a new session is illustrated.

According to an embodiment, in operation 1301, the listener C 1330 may make a request for establishing a session with the executor B 1320 to the executor B 1320 while the listener A 1310 is establishing a session with the executor B 1320.

According to an embodiment, in operation 1303, the executor B 1320 may transmit, to the listener A 1310 of the previously-established session, a message for determining whether to accept a request for establishing a new session.

According to an embodiment, in operation 1305, when the listener A 1310 accepts the request for establishing the new session, the new session between the listener C 1330 and the executor B 1320 may be established, and the existing session between the listener A 1310 and the executor B 1320 may be released.

According to an embodiment, in operation 1307, when the listener A 1310 rejects the request for establishing the new session, the existing session between the listener A 1310 and the executor B 1320 may be maintained, and the executor B 1320 may notify the listener C 1330 that a session establishment request has been rejected.

According to an embodiment, a case of FIG. 13A may be utilized when there is a request for establishing a new session from the listener C 1330 corresponding to a user account different from that of the listener A 1310.

Referring to FIG. 13B, an operation at a point in time when a listener (e.g., the listener C 1330) requesting a new session has priority over a listener (e.g., the listener A 1310) establishing the existing session is illustrated.

According to an embodiment, in operation 1309, a session may be established between the listener A 1310 and the executor B 1320.

According to an embodiment, in operation 1311, the listener C 1330 may transmit a request for establishing a new session to the executor B 1320.

According to an embodiment, in operation 1313, the previously-established session between the listener A 1310 and the executor B 1320 may be released, and a new session between the listener C 1330 and the executor B 1320 may be established.

According to an embodiment, a case of FIG. 13B may be utilized when the listener C 1330 corresponds to a user account that is identical to or different from that of the listener A 1310.

FIGS. 13C and 13D are examples of a case that multi-sessions (e.g., integrated session) are established. For example, the case of establishing multi-sessions indicates that sessions for an utterance processing request of each listener (1310, 1330) for the executor 1320 operate in parallel. In other words, the case of establishing multi-sessions indicates that a previously-established session is not released, but a new session is additionally generated or an existing session and a new session are integrated and processed.

FIG. 13C illustrates a case that sessions are integrated.

According to an embodiment, in operation 1315, a session may be established between the listener A 1310 and the executor B 1320.

According to an embodiment, in operation 1317, the listener C 1330 may transmit a request for establishing a new session to the executor B 1320.

According to an embodiment, in operation 1319, when a specified condition is satisfied, an integrated session may be established by integrating the previously-established session between the listener A 1310 and the executor B 1320 and the newly-established session between the listener C 1330 and the executor B 1320. For example, both an utterance received through the listener A 1310 and an utterance received through the listener C 1330 may be processed in the integrated session. For example, a result (i.e., a result obtained as the executor performs an operation corresponding to an utterance) of processing an utterance in the executor may be provided to the listener A 1310 and/or the listener C 1330 that constitutes the integrated session.

FIG. 13D illustrates a case that multi-sessions are maintained without integrating sessions.

According to an embodiment, in operation 1321, the listener A 1310 and the executor B 1320 may establish a first session.

According to an embodiment, in operation 1323, the listener C 1330 may transmit a request for establishing a new session to the executor B 1320.

According to an embodiment, in operation 1325, the listener C 1330 may establish a second session with the executor B 1320. For example, each of the listener A 1310 and the listener C 1330 may establish an independent session with the executor B 1320. For example, a result of the executor B 1320 performing an operation corresponding to an utterance received by the listener A 1310 may be provided to the listener A 1310 through the first session. The result of the executor B 1320 performing an operation corresponding to an utterance received by the listener C 1330 may be provided to the listener C 1330 through the second session.

According to an embodiment, in a case of FIG. 13D, when an utterance received by each listener (1310, 1330) is an utterance processed in the same capsule, or when the collision occurs because goals (e.g., an operation to be performed by the executor) of utterances received by each listener (1310, 1330) are the same as each other, the request for establishing a new session (e.g., the second session) may be rejected. For example, when the listener C 1330 receives an utterance of “play program CCC on TV” after the listener A 1310 receives an utterance of “play program AAA on TV”, the utterances received by the listener A 1310 and the listener C 1330 may collide with each other because the goals as “play the specified program” are the same as each other. In this case, the executor B 1320 may notify the listener C 1330 that an operation corresponding to an utterance requested by the listener A 1310 is currently being processed, and then may reject the request for establishing a new session (e.g., the second session). According to an embodiment, in a case of FIG. 13D, when utterances received by each listener (1310, 1330) are processed in different capsules from one another, or when goals (e.g., an operation to be performed by the executor) of utterances received by each listener (1310, 1330) are different from each other, a request for establishing a new session (e.g., the second session) may be accepted. For example, when the listener C 1330 receives an utterance “turn up the volume of TV” after the listener A 1310 receives an utterance of “play program AAA on TV”, because the utterances received by the listener A 1310 and the listener C 1330 have different goals, the goals do not collide with each other. Accordingly, the executor B 1320 may establish a new session (the second session), and may perform an operation corresponding to a request (e.g., an utterance received by each of the listener A 1310 and the listener C 1330) of each of the listener A 1310 and the listener C 1330.

According to an embodiment, an electronic device (e.g., the electronic device 101 of FIG. 1, the intelligence server 200 of FIG. 2, the electronic device 700 of FIG. 7, and/or the server 860 of FIG. 8) may include a communication circuit, a memory, and a processor operatively connected to the communication circuit and the memory. The memory stores instructions that, when executed, cause the processor to recognize a second external device that will perform an operation corresponding to a first utterance received by a first external device, to establish a first session between the first external device and the second external device, to recognize a device, which will perform an operation corresponding to a second utterance received by a third external device, while maintaining the first session, to determine whether to establish a second session between the third external device and the second external device based on a specified first condition when the device that will perform the operation corresponding to the second utterance is the second external device, and to establish the second session independently of the first session or establish an integrated session between the first external device, the second external device, and the third external device by integrating the first session and the second session when establishing the second session, on a basis of a specified second condition.

According to an embodiment, the first condition may include whether the operation corresponding to the first utterance is identical to the operation corresponding to the second utterance.

According to an embodiment, the second condition may include at least one of a case that the first external device and the third external device use an identical account, a case that a session lock time of the first session has not elapsed, a case that the first external device is activated, and a case that an elapsed time after the first utterance is received is within a specified time.

According to an embodiment, the instructions may cause the processor to set a session lock time of each of the first session, the second session, or the integrated session based on at least one of information of the first utterance, information of the second utterance, an attribute of the first external device, and an attribute of the second external device.

According to an embodiment, the instructions may cause the processor to store session information including at least one of information of a device receiving an utterance, information of a device performing an operation corresponding to an utterance, a session creation time, a session expiration time, a session lock time, a time when a last utterance is received in a session, and information of an utterance received in a session, in the memory with respect to each established session.

According to an embodiment, the instructions may cause the processor to update the stored session information when the operation corresponding to the first utterance or the operation corresponding to the second utterance is completed by the second external device.

According to an embodiment, the instructions may cause the processor to provide a response according to the completed operation to at least one of the first external device and the third external device when the operation corresponding to the first utterance or the operation corresponding to the second utterance is completed by the second external device.

According to an embodiment, the instructions may cause the processor to determine an external device, which will be provided with the response, based on at least part of a type or state of the first external device, a type or state of the second external device, a session lock time of the first session, a session lock time of the second session, a reception time of the first utterance, and a reception time of the second utterance.

According to an embodiment, the instructions may cause the processor to release the integrated session based on states of the first external device and the third external device that are associated with the integrated session.

According to an embodiment, the instructions may cause the processor to provide a response according to the release of the integrated session to at least one of the first external device and the third external device.

According to an embodiment, the instructions may cause the processor to determine whether to separate the first session or the second session from the integrated session based on states of the first external device and the third external device, which are associated with the integrated session when establishing a new session by integrating the integrated session and a third session between a fourth external device and the second external device.

According to an embodiment, the instructions may cause the processor to provide a session separation result to an external device corresponding to a session separated from the integrated session.

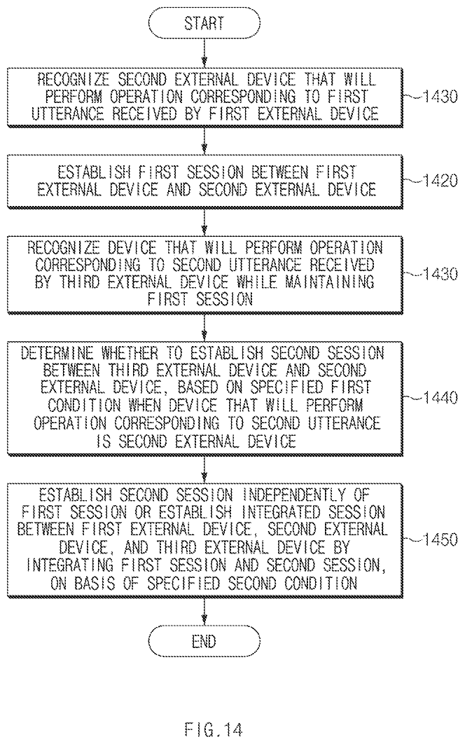

FIG. 14 is a flowchart of an operating method of an electronic device, according to an embodiment.

According to an embodiment, in operation 1410, an electronic device (e.g., the electronic device 101 of FIG. 1, the intelligence server 200 of FIG. 2, the first server 503 of FIG. 5, the electronic device 700 of FIG. 7, and/or the server 860 of FIG. 8) may recognize a second external device (e.g., the executor 820 in FIG. 8) that will perform an operation corresponding to a first utterance received by a first external device (e.g., the first listener 811 in FIG. 8). For example, the first external device may be a device (hereinafter, a ‘first listener’) that receives an utterance. The second external device may be a device (hereinafter, an ‘executor’) that performs an operation corresponding to an utterance. For example, the electronic device may receive the first utterance, which is received by the first external device, from the first external device. For example, the electronic device may determine a second external device, which will perform an operation corresponding to the first utterance, based on the received first utterance.

According to an embodiment, in operation 1420, the electronic device may establish a first session between the first external device and the second external device. According to an embodiment, a session may mean a connection or binding state between a listener and an executor until the executor performs at least one operation in response to an utterance received by the listener. For example, the session may mean a logical connection or binding state between the listener and the executor, which is used to perform an operation corresponding to an utterance.

According to an embodiment, in operation 1430, the electronic device may recognize a device, which will perform an operation corresponding to a second utterance received by a third external device (e.g., the second listener 813 in FIG. 8) while maintaining the first session. For example, the third external device may be a device (hereinafter, a ‘second listener’) that receives an utterance. For example, the electronic device may receive the second utterance, which is received by the third external device, from the third external device. For example, the electronic device may determine an external device, which will perform an operation corresponding to the second utterance, based on the received second utterance. For example, the electronic device may determine whether an external device that will perform the operation corresponding to the second utterance is the second external device.

According to an embodiment, when the device that will perform the operation corresponding to the second utterance is the second external device, in operation 1440, the electronic device may determine whether to establish a second session between the third external device and the second external device, based on a specified first condition. For example, when both a device, which will perform an operation corresponding to the first utterance, and a device, which will perform an operation corresponding to the second utterance are identical to each other as the second external device, the electronic device may determine whether to establish the second session between the third external device and the second external device. According to an embodiment, the first condition may include whether an operation corresponding to the first utterance is identical to an operation corresponding to the second utterance. For example, when an operation corresponding to the first utterance is identical to an operation corresponding to the second utterance, the electronic device may notify the third external device that session establishment is rejected without establishing a second session between the third external device and the second external device to prevent an executor from performing a redundant operation. As another example, when a goal of an operation corresponding to the first utterance collides with a goal of the operation corresponding to the second utterance, the electronic device may notify the third external device that session establishment is rejected without establishing the second session between the third external device and the second external device.

According to an embodiment, the electronic device may notify the first external device that the third external device has requested the establishment of the second session. According to an embodiment, the electronic device may establish a second session based on whether the first external device has accepted or rejected the establishment of the second session between the third external device and the second external device. For example, when the first external device accepts the establishment of the second session, the electronic device may determine to establish the second session and may maintain or release the first session. For example, when the first external device rejects to establish the second session, the electronic device may maintain the first session and may notify the third external device that the establishment of the second session is rejected.

According to an embodiment, in operation 1450, on the basis of a specified second condition, the electronic device may establish the second session independently of the first session, or may establish an integrated session between the first external device, the second external device, and the third external device, by integrating the first session and the second session. According to an embodiment, the specified second condition may include at least one of a case that the first external device and the third external device use the same account, a case that a session lock time of the first session has not elapsed, a case that the first external device is activated (e.g., a state where the display of the first external device is turned on or a state where the first external device is connected to a network), and a case that the elapsed time after the first utterance is received from the first external device is not greater than a specified time (e.g., a session retention reference value (e.g., half of a session lock time)). For example, the session lock time may be a time set to maintain a session after a session is established. For example, when a new utterance is received while the session is maintained, the session lock time may be initialized (reset). For example, the specified time (e.g., a session retention reference value) may be a reference value for determining whether to integrate an existing session and a new session when a new session is established. According to various embodiments, the specified second condition is not limited to the cases. The specified second condition may be set variously based on at least part of states of the first external device and third external device, a state of the previously-established session, and utterances received from the first external device and the third external device.

For example, when the first external device and the third external device use the same account, and when the elapsed time is within the session lock time of the first session or the elapsed time after the first external device receives the first utterance is within the specified time (e.g., half of a session lock time), the electronic device may establish an integrated session by integrating the first session and the second session. For example, when the first external device and the third external device use different accounts from each other, or a maintenance time (or a session lock time) of the first session has elapsed, or when the elapsed time after the first external device receives the first utterance exceeds a specified time (e.g., half of a session lock time), the electronic device may establish a second session independently of the first session.

According to an embodiment, the electronic device may set the session lock time of each of the first session, the second session, or the integrated session based on at least one of information of the first utterance, information of the second utterance, an attribute of the first external device, and an attribute of the third external device.

According to an embodiment, with respect to each established session, the electronic device may store, in a memory, session information including at least one of information of a device receiving an utterance, information of a device performing an operation corresponding to an utterance, session-related information (e.g., a session creation time, a session expiration time, a session lock time, and a time when the last utterance was received within a session), and information of an utterance received in a session. According to an embodiment, when an operation corresponding to a first utterance or an operation corresponding to a second utterance is completed by the second external device, the electronic device may update session information stored in the memory. According to an embodiment, when a new session is added to the integrated session, the electronic device may update the session creation time, session lock time, or session expiration time of the integrated session.

According to an embodiment, when an operation corresponding to an utterance received from a plurality of listeners (e.g., the first listener and the second listener) corresponds to an operation performed by the same executor, the electronic device may independently establish the first session between the first listener and the executor and the second session between the second listener and the executor based on the specified condition, or may establish an integrated session by integrating the first session and the second session.

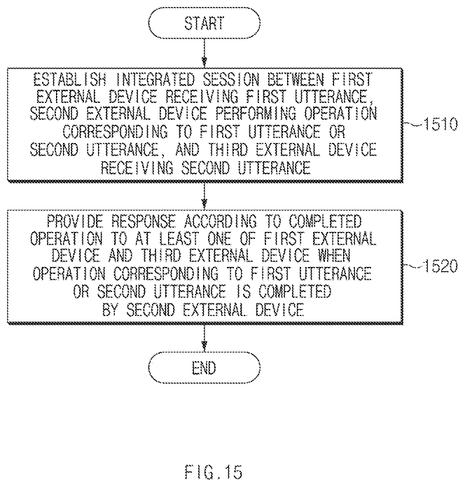

FIG. 15 is a flowchart of an operating method of an electronic device, according to an embodiment.

According to an embodiment, in operation 1510, an electronic device (e.g., the electronic device 101 of FIG. 1, the intelligence server 200 of FIG. 2, the first server 503 of FIG. 5, the electronic device 700 of FIG. 7, and/or the server 860 of FIG. 8) may establish an integrated session between a first external device (hereinafter, a ‘first listener’) (e.g., the first listener 811 in FIG. 8) receiving a first utterance, a second external device (hereinafter, an ‘executor’) (e.g., the executor 820 of FIG. 8) performing an operation corresponding to the first utterance or a second utterance, and a third external device (hereinafter, a ‘second listener’) (e.g., the second listener 813 in FIG. 8) receiving the second utterance.

According to an embodiment, when an operation corresponding to the first utterance or the second utterance is completed by the second external device, in operation 1520, the electronic device may provide a response according to a completed operation to at least one of the first external device and the third external device.

According to an embodiment, the electronic device may determine an external device, which will be provided with a response according to an operation completed by the second external device, based on at least part of the type or state of the first external device, the type or state of the third external device, the session lock time of the first session, the session lock time of the second session, the reception time of the first utterance, and the reception time of the second utterance.

According to an embodiment, when the second external device is connected to a single session (e.g., the first session or the second session), the electronic device may provide a result of performing an operation corresponding to an utterance by the second external device to an external device maintaining a session, and then may provide a session release result to a listener of which the session is released or of which session establishment is rejected. According to an embodiment, when the second external device is connected to the integrated session, the electronic device may provide a listener requesting for processing the utterance with a result of performing an operation corresponding to an utterance by the second external device. According to an embodiment, when the second external device is connected to the integrated session, the electronic device may provide a result of performing an operation corresponding to an utterance to a listener, which is in an active state from among listeners connected to the integrated session, and which satisfies a condition that a time elapsed after the final utterance is received is not greater than a session retention reference value (e.g., half of a session lock time). For example, the activation state may include a case that a listener's display is turned on, a case that the listener is connected to a network, a case that a listener is in an unlocked state, and/or a case that a listener is not in a power saving state. According to an embodiment, the electronic device may not provide the result of performing the operation corresponding to the utterance to a listener, which is not in an active state among listeners connected to the integrated session, or which satisfies a condition that the time elapsed after the final utterance is received exceeds the session retention reference value (e.g., half of a session lock time).

According to an embodiment, the electronic device may determine a device, which will be provided with a response according to an operation corresponding to the completed utterance, based on an attribute (e.g., capability) or type of the first external device and the third external device. For example, when the first external device is a mobile terminal including a display and the third external device is a smart speaker that does not include a display, the electronic device may provide a response to the first external device through which a user is capable of easily identifying the response (i.e., an operation execution result) according to an operation.

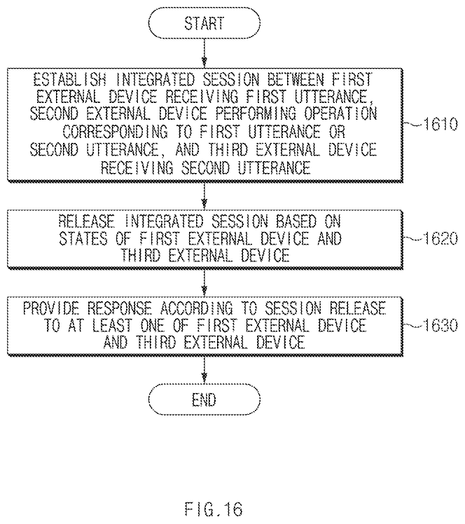

FIG. 16 is a flowchart of an operating method of an electronic device, according to an embodiment.

According to an embodiment, in operation 1610, an electronic device (e.g., the electronic device 101 of FIG. 1, the intelligence server 200 of FIG. 2, the first server 503 of FIG. 5, the electronic device 700 of FIG. 7, and/or the server 860 of FIG. 8) may establish an integrated session between a first external device (e.g., the first listener 811 in FIG. 8) receiving a first utterance, a second external device (e.g., the executor 820 of FIG. 8) performing an operation corresponding to the first utterance or a second utterance, and a third external device (e.g., the second listener 813 in FIG. 8) receiving the second utterance.

According to an embodiment, in operation 1620, the electronic device may separate or release the integrated session based on states of the first external device and the third external device. For example, when at least one of the first external device and the third external device, which is connected to the integrated session, is inactivated, the electronic device may separate or release the integrated session. According to an embodiment, when the executor completes an operation corresponding to an utterance, the electronic device may release the integrated session.

According to an embodiment, in operation 1630, the electronic device may provide a response according to session release to at least one of the first external device and the third external device. For example, the electronic device may separate the integrated session into a first session between the first external device and the executor and a second session between the third external device and the executor. For example, when the electronic device releases at least one of the separated first session and second session, the electronic device may provide a response according to session release to a listener corresponding to the released session.

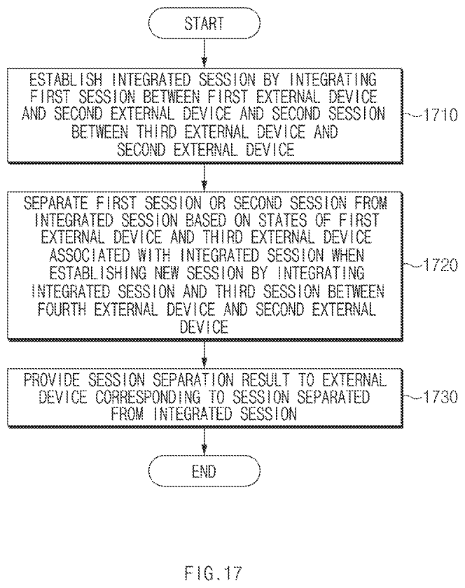

FIG. 17 is a flowchart of an operating method of an electronic device, according to an embodiment.

According to an embodiment, in operation 1710, an electronic device (e.g., the electronic device 101 of FIG. 1, the intelligence server 200 of FIG. 2, the first server 503 of FIG. 5, the electronic device 700 of FIG. 7, and/or the server 860 of FIG. 8) may establish a first integrated session by integrating a first session between a first external device (e.g., the first listener 811 in FIG. 8) and a second external device (e.g., the executor 820 of FIG. 8) and the second session between a third external device (e.g., the second listener 813 in FIG. 8) and the second external device.

According to an embodiment, in operation 1720, when establishing a new session by integrating the first integrated session and a third session between a fourth external device and the second external device, the electronic device may separate the first session or the second session from the first integrated session based on states of the first external device and the third external device associated with the first integrated session. For example, when a new single session is added to the first integrated session, the electronic device may separate at least one of the single sessions included in the first integrated session. For example, the electronic device may separate a session associated with a device, which is not activated (e.g., a display off state, a network disconnection state, a sleep state, a lock state, and/or a power off state), from among the first external device and the third external device from the first integrated session. For example, when establishing a second integrated session by adding a third session to the first integrated session obtained by integrating the first session and the second session, the electronic device may separate at least one of the first session and the second session into a single session. For example, when separating the first session from the first integrated session, the electronic device may integrate the second session and the third session, may manage the integrated session as a second integrated session, and may manage the first session, which is separated from the first integrated session, as a single session. For example, when separating the second session from the first integrated session, the electronic device may integrate the first session and the third session, may manage the integrated session as the second integrated session, and may manage the second session, which is separated from the first integrated session, as a single session. According to an embodiment, when at least part of single sessions is separated from the first integrated session, the electronic device may update the information of the first integrated session based on the information of the sessions that remain in the first integrated session. For example, the electronic device may update information of the first establishment time (a connection time) of the first integrated session to information of a session in which the first establishment time (a connection time) is oldest, from among sessions included in the first integrated session other than the separate session. For example, when configurations of sessions included in the integrated session (e.g., the first integrated session or the second integrated session) is changed, the electronic device may reset information (e.g., a session maintenance time) associated with the integrated session.

According to an embodiment, in operation 1730, the electronic device may provide a session separation result to an external device corresponding to a session separated from the first integrated session. According to an embodiment, the electronic device may release a separate session.

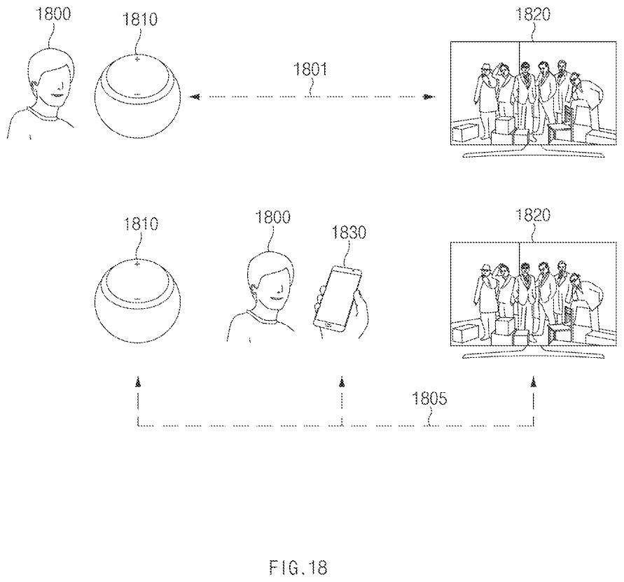

FIG. 18 is a diagram illustrating an operation of an intelligent assistance system, according to an embodiment.

According to an embodiment, FIG. 18 illustrates an example of managing a session between a listener (e.g., a first listener 1810 and/or a second listener 1830) and an executor 1820 as a single session 1801 or an integrated session 1805 in an intelligent assistance system including a plurality of listeners (e.g., the first listener 1810 and the second listener 1830) and the executor 1820. According to an embodiment, the session of the intelligent assistance system may be managed by an electronic device (not shown) (e.g., the electronic device 101 of FIG. 1, the intelligence server 200 of FIG. 2, the first server 503 of FIG. 5, the electronic device 700 of FIG. 7, and/or the server 860 of FIG. 8).

For example, 1801 indicates that the single session 1801 is established between the first listener 1810 and the executor 1820. For example, the single session 1801 may be a session established between one listener (e.g., the first listener 1810) and the one executor 1820. For example, when the utterance of a user 1800 is received by the first listener 1810, a first session between the first listener 1810 and the executor 1820 may be established. For example, in the case where the second session between the second listener 1830 and the executor 1820 is requested in a state where the first session between the first listener 1810 and the executor 1820 is established, when the first session is released while the second session between the second listener 1830 and the executor 1820 is established, or the first session is maintained while a request for establishing a second session is rejected, the single session 1801 may be established. For example, when the first session between the first listener 1810 and the executor 1820 is established, an operation corresponding to the utterance of the user 1800 received by the first listener 1810 may be performed by the executor 1820.

According to an embodiment, 1805 indicates that the integrated session 1805 is established between the first listener 1810, the second listener 1830, and the executor 1820. For example, the utterance of the user 1800 may be received by the second listener 1830 in a state where the first session is established between the first listener 1810 and the executor 1820. For example, when the second session between the second listener 1830 and the executor 1820 is requested based on the utterance of the user 1800 received by the second listener 1830, the integrated session 1805 may be established by integrating the first session between the first listener 1810 and the executor 1820 and the second session between the second listener 1830 and the executor 1820. For example, information between the first listener 1810, the second listener 1830, and the executor 1820 may be shared in the integrated session 1805. For example, when the first integrated session 1805 is established, an operation corresponding to the utterance of the user 1800 received by the first listener 1810 and/or the second listener 1830 may be performed by the executor 1820.

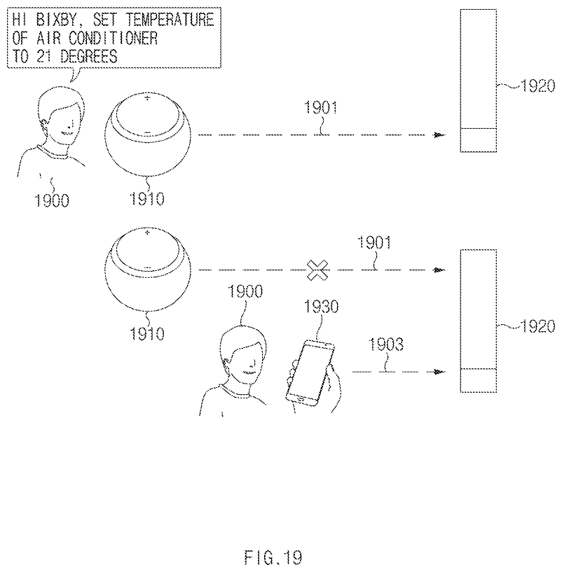

FIG. 19 is a diagram illustrating an operation of an intelligent assistance system, according to an embodiment.

FIG. 19 shows an example of managing a session between devices (e.g., a first listener 1910 and/or a second listener 1930, and an executor 1920) based on an attribute (e.g., capability) of the devices (e.g., the first listener 1910 and the second listener 1930). According to an embodiment, the session of the intelligent assistance system may be managed by an electronic device (not shown) (e.g., the electronic device 101 of FIG. 1, the intelligence server 200 of FIG. 2, the first server 503 of FIG. 5, the electronic device 700 of FIG. 7, and/or the server 860 of FIG. 8).

According to an embodiment, in operation 1901, when a first utterance of a user 1900 is received by the first listener 1910, a first session may be established between the first listener 1910 and the executor 1920. The user 1900 may control the operation of the executor 1920 through the first listener 1910. For example, when the first listener 1910 receives the first utterance saying that “Hi Bixby, set the temperature of the air conditioner to 21 degrees”, the executor 1920 may perform an operation (e.g., set the temperature of the air conditioner to 21 degrees) corresponding to the first utterance through the first session.

According to an embodiment, in operation 1903, when a second utterance of the user 1900 is received by the second listener 1930, a second session may be established between the second listener 1930 and the executor 1920. For example, when the second listener 1930 receives the second utterance saying that “Hi Bixby, set the temperature of the air conditioner to 18 degrees”, the executor 1920 may perform an operation (e.g., set the temperature of the air conditioner to 18 degrees) corresponding to the second utterance through the second session.

According to an embodiment, in this case, whether to maintain the first session and the second session as a single session or to manage the first session and the second session as an integrated session may be determined based on an attribute (e.g., account information of each listener or device information) of a listener or information of an utterance.

According to an embodiment, when each of the first session and the second session is established as a single session, the first session or the second session may be released (terminated) based on attributes (e.g., capabilities) of the devices (e.g., the first listener 1910 and the second listener 1930). For example, on the basis of the attribute of a plurality of listeners, the intelligent assistance system may maintain a session between the listener and the executor 1920, which is more suitable to provide an operation execution result of the executor 1920, from among single sessions between the same executor 1920 and each of a plurality of listeners, and then may release the remaining sessions. For example, when the first listener 1910 is a device (e.g., a smart speaker) that does not include a display that displays the operation execution result of the executor 1920, and the second listener 1930 is a device (e.g., a mobile terminal) including a display that displays the operation execution result of the executor 1920, the first session may be released, and the operation execution result of the executor 1920 may be provided to the second listener 1930 through the second session. As another example, when both the first listener 1910 and the second listener 1930 may provide the operation execution result of the executor 1920, both the first session and the second session may be maintained. For example, the first listener 1910 may provide the operation execution result of the executor 1920 through an indication from at least one LED or by voice. The second listener 1930 may display the operation execution result of the executor 1920 on a display.

According to an embodiment, each of the first session and the second session may be released after a session lock time (or a session termination time), which is set when a session is established, has elapsed. For example, the session lock time may be extended when an additional utterance is received from the user 1900. For example, each of the first session and the second session may be released after the session lock time has elapsed since each of the first listener 1910 and the second listener 1930 received the last utterance.

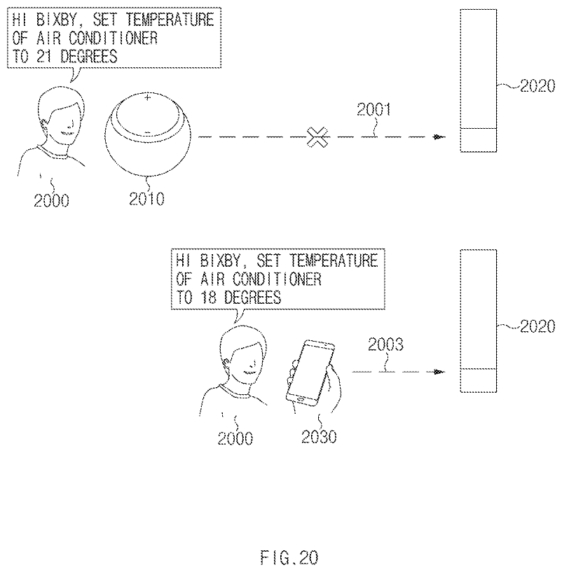

FIG. 20 is a diagram illustrating an operation of an intelligent assistance system, according to an embodiment.

FIG. 20 illustrates an example of managing a session based on an attribute of an utterance received from a user 2000. According to an embodiment, the session of the intelligent assistance system may be managed by an electronic device (not shown) (e.g., the electronic device 101 of FIG. 1, the intelligence server 200 of FIG. 2, the first server 503 of FIG. 5, the electronic device 700 of FIG. 7, and/or the server 860 of FIG. 8).

According to an embodiment, when the first utterance of the user 2000 is received by a first listener 2010, a first session is established between the first listener 2010 and an executor 2020. When the second utterance of the user 2000 is received by a second listener 2030, a second session may be established between the second listener 2030 and the executor 2020. In this case, the first session or the second session may be integrated, maintained, or released based on the attributes of the first and second utterances.

According to an embodiment, the electronic device may identify the attribute (e.g., an incomplete utterance or a complete utterance) or type (e.g., a root utterance or a follow-up utterance) of the first utterance and the second utterance as the analysis result of the first utterance and the second utterance.

For example, when the first utterance or the second utterance has an attribute, which has discontinuity in continuous utterances, or which does not require an additional command (utterance), a first session and a second session, which are used to perform an operation corresponding to the first utterance or the second utterance may be established as a single session. When the first utterance or the second utterance has an attribute that requires a continuous conversation or an additional command (utterance), the first session and the second session may be managed as an integrated session.

For example, the electronic device may identify that the first utterance and the second utterance are utterances having continuous attributes based on identifying that the type of the first utterance is a root utterance and the type of the second utterance is a follow-up utterance, as an analysis result of the first utterance and/or the second utterance.

According to an embodiment, to perform a specified operation requested by a user, the root utterance may be a user utterance first obtained by the electronic device after a session is established. For example, after obtaining a user utterance for requesting the generation of a session in a state where session is not generated, the electronic device may obtain a user utterance for requesting a specified operation (e.g., “play program AAA on TV”). In this case, an utterance for requesting a specified operation (e.g., play program AAA) may mean a root utterance.

According to an embodiment, the root utterance may mean a user utterance for calling a domain for the first time after a session is generated, or a user utterance for calling a new second domain while a user utterance is processed by calling a first domain within a session.

According to an embodiment, the follow-up utterance may be a user utterance associated with a root utterance. The follow-up utterance may mean a series of user utterances that are additionally obtained after the root utterance is obtained. For example, after the electronic device obtains a user utterance (e.g., “Hi Bixby, play program AAA on TV”) from the listener, an executor may output a message (e.g., “Which episode do you want to play?”) for requesting additional information through a listener, and may obtain an additional user utterance (e.g., “Play episode 340”), which responds to the message, from the listener. In this case, the additional user utterance associated with the root utterance may mean a follow-up utterance. After the electronic device obtains the root utterance, the electronic device may obtain a first follow-up utterance successive to the root utterance. After the electronic device obtains the first follow-up utterance, the electronic device may obtain a second follow-up utterance successive to the first follow-up utterance. In this case, the root utterance may be a preceding utterance of a first follow-up utterance. The first follow-up utterance may be a preceding utterance of the second follow-up utterance.

For example, when a new utterance is entered in a situation (e.g., a state where an utterance processing result screen is maintained, or a state where a session corresponding to an utterance is maintained (e.g., a state where a request ID corresponding to an utterance is maintained)) that satisfies the specified condition, the electronic device may recognize the new utterance as a second utterance (e.g., a follow-up utterance) successive to the first utterance (e.g., a root utterance). For example, in a situation that satisfies the specified condition, the electronic device may recognize a second utterance, which is entered without explicitly specifying a different capsule or device, as a follow-up utterance successive to the first utterance.

For example, in a situation where a session between the listener 2010 or 2030 and the executor 2020 is established, the electronic device may determine that an additional utterance delivered without device dispatch is a continuous utterance (follow-up utterance), and then may control the executor 2020, which belongs to a current session, to process the corresponding utterance.

For example, the electronic device may identify that the first utterance is an utterance having an attribute that requires an additional command (utterance) based on identifying that the type of the first utterance is the root utterance, the attribute of the first utterance is an incomplete utterance, and the attribute of the second utterance is a follow-up utterance, as the analysis result of the first utterance and/or the second utterance. According to an embodiment, the incomplete utterance may mean a user utterance that requires additional information because an operation corresponding to the user utterance is incapable of being performed by using only the analysis result of the obtained user utterance. The complete utterance may mean a user utterance capable of performing an operation corresponding to the user utterance by using only the analysis result of the obtained user utterance.

According to an embodiment, the electronic device may identify that an utterance, not an incomplete utterance, is a complete utterance.

According to an embodiment, the electronic device may identify that the attribute of first utterance is incomplete utterance, based on an event that at least one of a domain, intent, or a mandatory parameter for the first utterance is not identified, as the analysis result of the first utterance.

According to an embodiment, the electronic device may determine whether the attribute of the first utterance is a complete utterance or an incomplete utterance, by using a deep-learning model.

According to an embodiment, when the received utterance is an incomplete utterance, the electronic device may induce a user to enter an additional utterance. For example, the electronic device may provide the user with a request for inducing the user to enter an additional utterance, through the listener (2010, 2030) that has received the utterance.

For example, when the first utterance received by the first listener 2010 is “Hi Bixby, set the temperature of the air conditioner to 21 degrees”, and the second utterance received by the second listener 2030 is “Hi Bixby, set the temperature of the air conditioner to 18 degrees”, operations corresponding to the first utterance and the second utterance may not need to be interlocked with each other. In this case, for example, in operation 2001, the existing first session may be released. In operation 2003, a new second session may be established and maintained. For example, on the basis of the priorities of the first listener 2010 and the second listener 2030, the existing first session may be maintained, and the establishment of a new second session may be rejected. For example, the first session between the first listener 2010 and the executor 2020 and the second session between the second listener 2030 and the executor 2020 are established as single sessions, respectively. When the executor 2020 performs an operation corresponding to the first utterance or the second utterance in each single session, the corresponding session may be released individually. For example, the first session may be released after the executor 2020 performs an operation corresponding to the first utterance. The second session may be released after the executor 2020 performs an operation corresponding to the second utterance.

As another example, when the first utterance received by the first listener 2010 is “Hi Bixby, change the temperature of air conditioner”, and the second utterance received by the second listener 2030 is “Set the temperature to 18 degrees”, the first utterance and the second utterance may have attributes of conversations that are continuous with each other, and an integrated session between the first listener 2010, the second listener 2030, and the executor 2020 may be established. For example, when the executor 2020 performs an operation (e.g., set the temperature of the air conditioner to 18 degrees) corresponding to the first utterance and the second utterance in the integrated session, the result of the operation performed by the executor 2020 may be provided to the first listener 2010 and/or the second listener 2030.

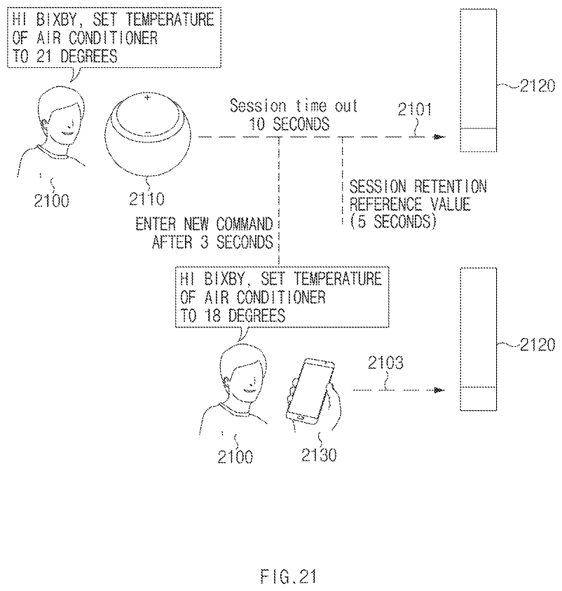

FIG. 21 is a diagram for describing an operation of an intelligent assistance system, according to an embodiment.

FIG. 21 illustrates an example of managing a session based on a session setting (e.g., a session lock time) of each device (e.g., a first listener 2110, a second listener 2130, and an executor 2120). According to an embodiment, the session of the intelligent assistance system may be managed by an electronic device (not shown) (e.g., the electronic device 101 of FIG. 1, the intelligence server 200 of FIG. 2, the first server 503 of FIG. 5, the electronic device 700 of FIG. 7, and/or the server 860 of FIG. 8).

According to an embodiment, a different session lock time may be set for each device. For example, a session lock time suitable for an attribute of a device may be set for each device. For example, when a listener is a smart refrigerator, an additional voice input (utterance) may be more likely to be entered than an additional physical input (e.g., touch input) after a user 2100 enters (utters) the first voice by virtue of the attribute of a device. For example, when a listener is a smart refrigerator, the session lock time that is relatively long (e.g. 1 minute) may be generally set when a session according to an utterance (e.g., “Show me a recipe”) is established. As another example, when a listener is a mobile terminal, because a command corresponding to various domains may be entered frequently by virtue of the attribute of a device, the efficiency may be reduced when the session lock time is too long. In the case of a mobile terminal, the session lock time may be generally set to a relatively-short time (e.g. 10 seconds) when a session according to an utterance (e.g., “Show me a recipe”) is established. According to various embodiments, in an MDE environment, because devices having various session lock times may be integrated and used, sessions in the MDE environment may be managed based on the session lock time set for each device and/or a participation time point at which devices participate in the MDE environment.

According to an embodiment, in operation 2101, the first listener 2110 may establish a first session with the executor 2120 based on the first utterance (e.g., “Hi Bixby, set the temperature of the air conditioner to 21 degrees”) of the user 2100. According to an embodiment, in operation 2103, the second listener 2130 may establish a second session with the executor 2120 based on the second utterance (e.g., “Hi Bixby, set the temperature of the air conditioner to 18 degrees”) of the user 2100.

According to an embodiment, on the basis of the session lock time set for each of the first listener 2110 and the second listener 2130, a first session between the first listener 2110 and the executor 2120 and a second session between the second listener 2130 and the executor 2120 may be maintained as single sessions or may be managed as an integrated session. For example, when a session lock time of 10 seconds is set for the first listener 2110 and the second listener 2130, the first listener 2110 may receive the first utterance, and then a first session may be established. Next, when the second utterance is received from the second listener 2130 after 5 seconds, the first session between the first listener 2110 and the executor 2120 and the second session between the second listener 2130 and the executor 2120 may be managed as an integrated session until the remaining 5 seconds of the session lock time of the first listener 2110. When 10 seconds that is the session lock time of the first listener 2110 have elapsed, the integrated session may be separated and the first session may be released. The second session may be maintained during the remaining time of the session lock time of the second listener 2130.

According to an embodiment, when a new listener is added to the MDE environment, the session lock time of each device may be controlled based on a point in time when a new listener is added. For example, in a state where the first session is established between the first listener 2110 and the executor 2120, the new the second listener 2130 may receive the utterance, and a second session between the second listener 2130 and the executor 2120 may be established. In this case, the session lock time of the first session may be initialized (reset) at a time (i.e., a point in time when the second listener 2130 receives an utterance) of establishing the second session, or the session lock time of the first session may be set to be the same as the session lock time of the second session.

According to an embodiment, as shown in FIG. 21, sessions between devices may be managed based on a point in time when the establishment of the second session is requested in the session lock time of the pre-established session (e.g., the first session). For example, it is assumed that a first session between the first listener 2110 and the executor 2120 is established based on the first utterance of the user 2100 and a session lock time of the first session is 10 seconds. For example, when the establishment of a second session between the second listener 2130 and the executor 2120 is requested based on the second utterance of the user 2100 after the first session is established, the first session and/or the second session may be controlled based on whether the corresponding time point is before or after the session retention reference value elapses during the session lock time of the first session. For example, when the second session is established before the session retention reference value of 5 seconds elapses among 10 seconds of the session lock time of the first session, the first session and the second session may be integrated and managed as an integrated session. As another example, when the second session is established after the session retention reference value of 5 seconds elapses among 10 seconds of the session lock time of the first session, the first session and the second session may be established or maintained as a single session, or the first session may be released and only the second session may be maintained.

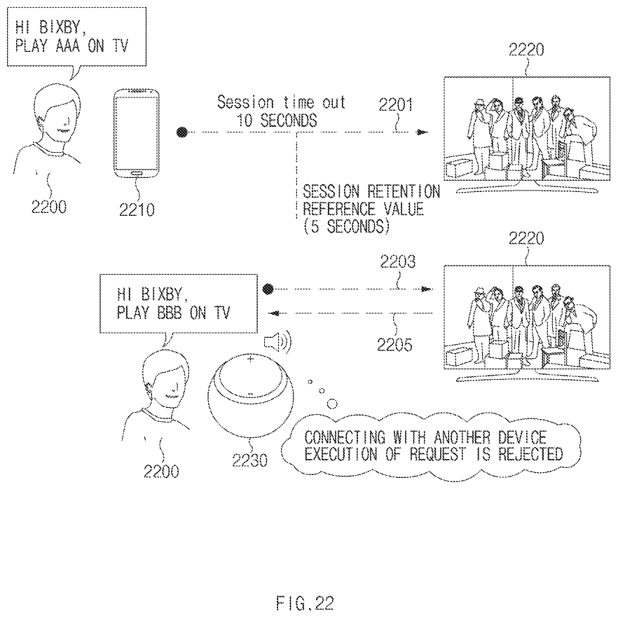

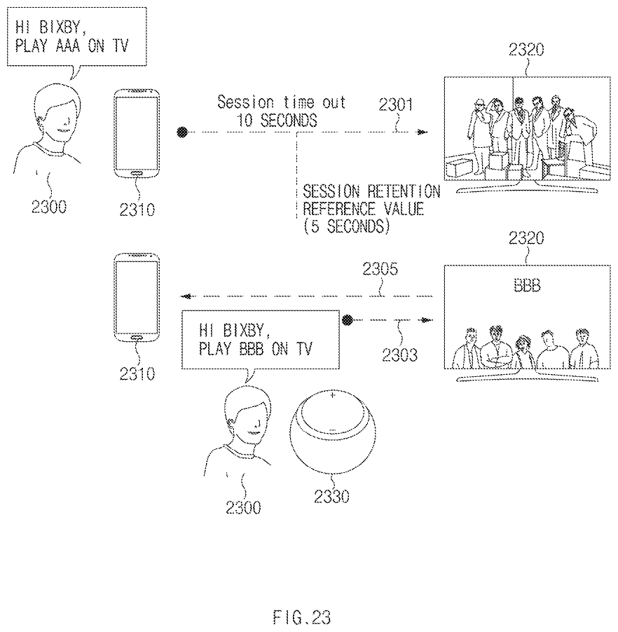

FIGS. 22 and 23 are diagrams illustrating an operation of an intelligent assistance system, according to an embodiment.

FIGS. 22 and 23 illustrate examples of a case that the priority of a single session is determined based on a session setting (e.g., a session lock time and a session retention reference value) of a listener (e.g., first listeners 2210 and 2310) and the reception time of an utterance (e.g., a second utterance). According to an embodiment, the session of the intelligent assistance system may be managed by an electronic device (not shown) (e.g., the electronic device 101 of FIG. 1, the intelligence server 200 of FIG. 2, the first server 503 of FIG. 5, the electronic device 700 of FIG. 7, and/or the server 860 of FIG. 8).

Referring to FIG. 22, according to an embodiment, in operation 2201, the first listener 2210 may establish a first session with an executor 2220 based on an utterance of a user 2200. For example, when the first listener 2210 receives a first utterance saying “Hi Bixby, play program AAA on TV” from the user 2200, the first listener 2210 may establish a first session, and the executor 2220 may perform an operation (e.g., play program AAA) corresponding to the first utterance. For example, the executor 2220 may provide the execution result of an operation corresponding to the first utterance to the first listener 2210.

According to an embodiment, the first session may have a set session lock time. According to an embodiment, in operation 2203, before the session retention reference value (e.g. half of the session lock time) elapses during the session lock time of the first session, the second listener 2230 may make a request for establishing a second session between the second listener 2230 and the executor 2220 based on a second utterance (“Hi Bixby, play program BBB on TV”) of the user 2200. According to an embodiment, when the establishment of the second session is requested before the session retention reference value elapses during the session lock time of the first session, the priority for session control may be given to the first listener 2210. For example, when the second listener 2230 makes a request for establishing a second session, the executor 2220 may notify the first listener 2210 that a new session (second session) has been requested. For example, when the first listener 2210 accepts the establishment of the second session, the first session may be released and the second session may be established. For example, when the first listener 2210 rejects the establishment of the second session, the first session may be maintained and a request for establishing the second session may be rejected.

According to an embodiment, in operation 2205, when the establishment of the second session is rejected, the executor 2220 may notify the second listener 2230 that the request for establishing the second session has been rejected. For example, the second listener 2230 may notify the user 2200 that the executor 2220 is currently connected to another device (the first listener 2210) and a request for establishing a new session has been rejected.

Referring to FIG. 23, according to an embodiment, in operation 2301, a first listener 2310 may establish a first session with an executor 2320 based on an utterance of a user 2300. For example, when the first listener 2310 receives a first utterance saying “Hi Bixby, play program AAA on TV” from the user 2300, the first listener 2210 may establish a first session, and the executor 2320 may perform an operation (e.g., play program AAA) corresponding to the first utterance. For example, the executor 2320 may provide the execution result of an operation corresponding to the first utterance to the first listener 2310.

According to an embodiment, the first session may have a set session lock time. According to an embodiment, in operation 2303, after the session retention reference value (e.g. half of the session lock time) elapses during the session lock time of the first session, the second listener 2330 may make a request for establishing a second session between the second listener 2330 and the executor 2320 based on a second utterance (“Hi Bixby, play program BBB on TV”) of the user 2300. According to an embodiment, when the establishment of the second session is requested after the session retention reference value elapses during the session lock time of the first session, the priority for session control may be given to the second listener 2330.

According to an embodiment, in operation 2305, the first session may be released, and the second session between the second listener 2330 and the executor 2320 may be established. According to an embodiment, the executor 2320 may perform an operation (e.g., play program BBB) corresponding to the second utterance of the user 2300 received by the second listener 2330 through the second session.

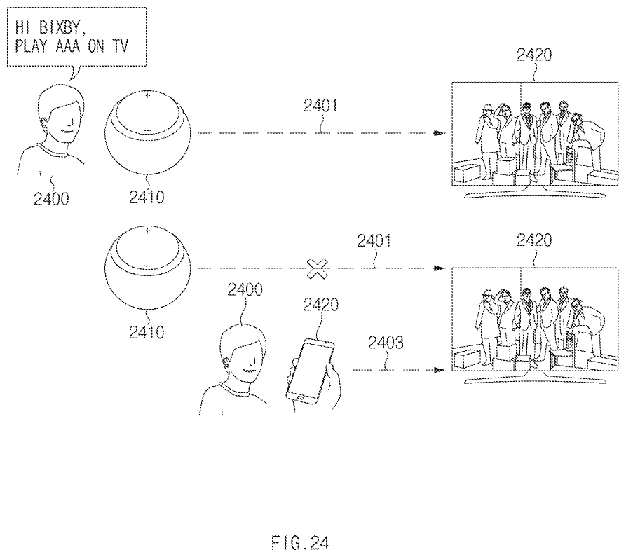

FIG. 24 is a diagram illustrating an operation of an intelligent assistance system, according to an embodiment.

FIG. 24 illustrates an example of controlling a session based on state information of each listener 2410 and 2430. According to an embodiment, a session of an intelligent assistance system may be controlled by an electronic device (not shown) (e.g., the electronic device 101 of FIG. 1, the intelligence server 200 of FIG. 2, the first server 503 of FIG. 5, the electronic device 700 of FIG. 7, and/or the server 860 of FIG. 8).

According to an embodiment, the intelligent assistance system may determine whether to manage the session for each listener 2410 and 2430 as a single session or as an integrated session, based on state information of each listener (e.g., the first listener 2410 and the second listener 2430).

For example, when a first utterance of a user 2400 is received by the first listener 2410, a first session may be established between the first listener 2410 and the executor 2420. The user 2400 may control the operation of the executor 2420 through the first listener 2410. For example, when the first listener 2410 receives a first utterance saying, “Hi Bixby, play program AAA on TV”, the executor 2420 may perform an operation (e.g., play program AAA) corresponding to the first utterance through the first session. Afterward, when a second utterance of the user 2400 is received by the second listener 2430, a second session may be established between the second listener 2430 and the executor 2420. In this case, on the basis of state information of the first listener 2410, the intelligent assistance system may manage the first session and the second session as an integrated session or may manage the first session and the second session as single sessions. For example, the state information may include at least one of an on/off state of a display of a listener, a network connection/disconnection state, whether the listener is locked, and whether the listener is in a power saving state. According to various embodiments, the state information is not limited to the above-mentioned descriptions, and may include various information associated with the listener. For example, when the display of the first listener 2410 is turned off, the first listener 2410 is not connected to a network, the first listener 2410 is locked, or the first listener 2410 is in a power saving state, the first session and the second session may be managed as single sessions. In this case, after the second session is established, the first session may be terminated and the second session may be maintained. As another example, when the display of the first listener 2410 is turned on, the first listener 2410 is connected to the network, the first listener 2410 is not locked, or the first listener 2410 is not in a power saving state, the first session and the second session may be integrated to establish an integrated session.

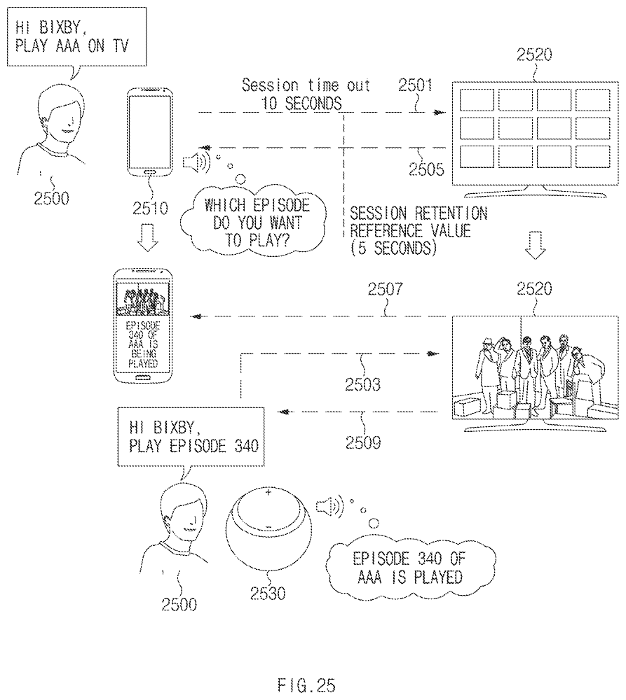

FIG. 25 is a diagram illustrating an operation of an intelligent assistance system, according to an embodiment.

FIG. 25 illustrates an example in which an executor 2520 synchronizes a result of performing an operation corresponding to an utterance with each listener based on an attribute of each listener. According to an embodiment, a result of performing an operation corresponding to an utterance in an intelligent assistance system may be synchronized to each listener by an electronic device (not shown) (e.g., the electronic device 101 of FIG. 1, the intelligence server 200 of FIG. 2, the first server 503 of FIG. 5, the electronic device 700 of FIG. 7, and/or the server 860 of FIG. 8).

According to an embodiment, in operation 2501, the first listener 2510 may establish a first session with the executor 2520 based on a first utterance (“Hi Bixby, play program AAA on TV”) of a user 2500. According to an embodiment, the first listener 2510 may request the executor 2520 to perform an operation corresponding to the first utterance through the first session.

According to an embodiment, in operation 2503, the executor 2520 may perform the operation corresponding to the first utterance. According to an embodiment, for the executor 2520 to perform an operation corresponding to the user's utterance, there is a need for a second utterance successive to the first utterance. According to an embodiment, the executor 2520 may additionally make a request for the second utterance of the user 2500 to the first listener 2510. For example, the first listener 2510 may output the voice to the user 2500, “which episode do you want to play?” based on the request of the executor 2520.

According to an embodiment, in operation 2505, a second listener 2530 may establish a second session with the executor 2520 in response to receiving the second utterance (“Hi Bixby, play episode 340”) of the user 2500. According to an embodiment, the first utterance and the second utterance may have attributes of a continuous conversation, and the first session and the second session may be managed as an integrated session. According to an embodiment, when the second utterance is received before the session retention reference value (e.g., 5 seconds) elapses during the session lock time (e.g., 10 seconds) of the first session, the first session and the second session may be managed as an integrated session. When the second utterance is received after the session retention reference value (e.g., 5 seconds) elapses during the session lock time (e.g., 10 seconds) of the first session, the first session and the second session may be managed as single sessions.

Hereinafter, it is assumed that the executor 2520 synchronizes a result of performing an operation corresponding to an utterance with each listener (2510, 2530) when the first session and the second session are managed as an integrated session. According to an embodiment, the executor 2520 may recognize information associated with the attribute of each listener (2510, 2530). For example, the executor 2520 may recognize that the first listener 2510 is a device including a display. The executor 2520 may recognize that the second listener 2530 is a device that does not include a display but includes a speaker. For example, the executor 2520 may request the first listener 2510 to display a result (e.g., play episode 340 in program AAA) of performing an operation corresponding to the first utterance and the second utterance on the display based on the recognized attribute of each listener, and may request the second listener 2530 to output a result of performing the operation corresponding to the first utterance and the second utterance through the speaker. According to an embodiment, when the executor 2520 identically provides each listener (2510, 2530) with a result of performing an operation corresponding to an utterance, each listener (2510, 2530) may provide the result of performing the operation corresponding to the utterance through an appropriate means based on the attribute of the listener (2510, 2530). For example, when the executor 2520 provides the result of performing the operation corresponding to the first utterance and the second utterance to each of the first listener 2510 and the second listener 2530, the first listener 2510 may display the corresponding result on the display, and the second listener 2530 may output the corresponding result through the speaker.

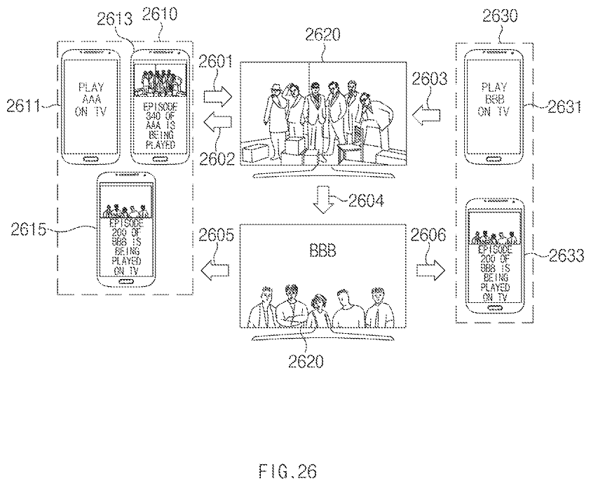

FIG. 26 is a diagram illustrating an operation of an intelligent assistance system, according to an embodiment.

According to an embodiment, in an intelligent assistance system, a session management operation between listeners 2610 and 2630 and an executor 2620 and an operation processing utterance may be controlled by an electronic device (not shown) (e.g., the electronic device 101 of FIG. 1, the intelligence server 200 of FIG. 2, the first server 503 of FIG. 5, the electronic device 700 of FIG. 7, and/or the server 860 of FIG. 8).

According to an embodiment, in operation 2601, the first listener 2610 may receive a first utterance “Play AAA on TV” from a user. For example, as illustrated in 2611, the first listener 2610 may display at least part of content of the received first utterance on a display. According to an embodiment, the first listener 2610 may establish a first session with the executor 2620 in response to the first utterance. According to an embodiment, the first listener 2610 may request the executor 2620 to perform an operation corresponding to the first utterance through the first session. According to an embodiment, the executor 2620 may perform an operation (e.g., play program AAA) corresponding to the first utterance based on the request of the first listener 2610.

According to an embodiment, in operation 2602, the executor 2620 may provide the first listener 2610 with information about a result of performing the operation corresponding to the first utterance. For example, the first listener 2610 may provide the result of performing the operation corresponding to the first utterance to the display based on the information received from the executor 2620. For example, as illustrated in 2613, the first listener 2610 may display the result of processing the first utterance such as “Playing episode 340 of AAA on TV” on the display.

According to an embodiment, in operation 2603, the second listener 2630 may receive a second utterance “Play BBB on TV” from the user. For example, as illustrated in 2631, the second listener 2630 may display at least part of content of the received second utterance on the display. According to an embodiment, the second listener 2630 may be present at a location different from the location of the first listener 2610. According to an embodiment, the second listener 2630 may establish a second session with the executor 2620 in response to the second utterance. According to an embodiment, the first session and the second session may be integrated based on a specified condition. For example, under the specified condition, the first session and the second session may be managed as single sessions, or the first session and the second session may be managed as an integrated session based on at least part of a state (e.g., a display on/off state, a network connection state, a lock state, and/or a power saving state) of the first listener 2610 and/or the second listener 2630, an attribute (e.g., the presence or absence of a display and/or the type of a device) of the first listener 2610 and/or the second listener 2630, a setting (e.g., a session lock time or a session maintenance setting value) of the first session and/or second session, and an attribute (e.g., the relationship between the first utterance and the second utterance) of the first utterance and/or the second utterance. According to an embodiment, the second listener 2630 may request the executor 2620 to perform an operation corresponding to the second utterance through an integrated session.

According to an embodiment, in operation 2604, the executor 2620 may perform an operation (e.g., play program BBB) corresponding to the second utterance based on the request of the second listener 2630. For example, the executor 2620 may change a program being played from program AAA to program BBB.

According to an embodiment, in operation 2605 and operation 2606, the executor 2620 may provide the first listener 2610 and the second listener 2630 with information about the result of performing the operation corresponding to the second utterance. For example, the first listener 2610 and the second listener 2630 may provide the result of performing the operation corresponding to the second utterance to the display based on the information received from the executor 2620. For example, as illustrated in 2615 and 2633, the first listener 2610 and the second listener 2630 may display the result of processing the second utterance such as “playing episode 200 of BBB on TV” on the display.

According to an embodiment, an operating method of an electronic device may include recognizing a second external device that will perform an operation corresponding to a first utterance received by a first external device, establishing a first session between the first external device and the second external device, recognizing a device, which will perform an operation corresponding to a second utterance received by a third external device, while maintaining the first session, determining whether to establish a second session between the third external device and the second external device based on a specified first condition when the device that will perform the operation corresponding to the second utterance is the second external device, and establishing the second session independently of the first session or establishing an integrated session between the first external device, the second external device, and the third external device by integrating the first session and the second session when establishing the second session, on a basis of a specified second condition.

According to an embodiment, the first condition may include whether the operation corresponding to the first utterance is identical to the operation corresponding to the second utterance.

According to an embodiment, the second condition may include at least one of a case that the first external device and the third external device use an identical account, a case that a session lock time of the first session has not elapsed, a case that the first external device is activated, and a case that an elapsed time after the first utterance is received is within a specified time.

According to an embodiment, the method may further include setting a session lock time of each of the first session, the second session, or the integrated session based on at least one of information of the first utterance, information of the second utterance, an attribute of the first external device, and an attribute of the second external device.

According to an embodiment, the method may further include updating the stored session information when the operation corresponding to the first utterance or the operation corresponding to the second utterance is completed by the second external device.

According to an embodiment, the method may further include providing a response according to the completed operation to at least one of the first external device and the third external device when the operation corresponding to the first utterance or the operation corresponding to the second utterance is completed by the second external device.

According to an embodiment, the method may further include releasing the integrated session based on states of the first external device and the third external device that are associated with the integrated session.

According to an embodiment, the method may further include determining whether to separate the first session or the second session from the integrated session based on states of the first external device and the third external device, which are associated with the integrated session when establishing a new session by integrating the integrated session and a third session between a fourth external device and the second external device.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the present disclosure has been particularly shown and described with reference to certain embodiments thereof, it will be understood by those of ordinary skill in the art that various changes in form and details may be made therein without departing from the spirit and scope of the disclosure as defined by the appended claims and their equivalents.

What is claimed is:

1. An electronic device comprising:
a communication circuit;
a memory; and
a processor operatively connected to the communication circuit and the memory,
wherein the memory stores instructions that, when executed, cause the processor to:
recognize a second external device that will perform an operation corresponding to a first utterance received by a first external device;
establish a first session between the first external device and the second external device;
recognize a device, which will perform an operation corresponding to a second utterance received by a third external device, while maintaining the first session;
when the device that will perform the operation corresponding to the second utterance is the second external device, determine whether to establish a second session between the third external device and the second external device based on a specified first condition; and
when establishing the second session, on a basis of a specified second condition, establish the second session independently of the first session or establish an integrated session between the first external device, the second external device, and the third external device by integrating the first session and the second session.

2. The electronic device of claim 1, wherein the first condition includes whether the operation corresponding to the first utterance is identical to the operation corresponding to the second utterance.

3. The electronic device of claim 1, wherein the second condition includes at least one of a case that the first external device and the third external device use an identical account, a case that a session lock time of the first session has not elapsed, a case that the first external device is activated, and a case that an elapsed time after the first utterance is received is within a specified time.

4. The electronic device of claim 1, wherein the instructions, when executed, further cause the processor to:
set a session lock time of each of the first session, the second session, or the integrated session based on at least one of information of the first utterance, information of the second utterance, an attribute of the first external device, and an attribute of the second external device.

5. The electronic device of claim 1, wherein the instructions, when executed, further cause the processor to:
store session information including at least one of information of a device receiving an utterance, information of a device performing an operation corresponding to an utterance, a session creation time, a session expiration time, a session lock time, a time when a last utterance is received in a session, and information of an utterance received in a session, in the memory with respect to each established session.

6. The electronic device of claim 5, wherein the instructions, when executed, further cause the processor to:
when the operation corresponding to the first utterance or the operation corresponding to the second utterance is completed by the second external device, update the stored session information.

7. The electronic device of claim 1, wherein the instructions, when executed, cause the processor to:
when the operation corresponding to the first utterance or the operation corresponding to the second utterance is completed by the second external device, provide a response according to the completed operation to at least one of the first external device and the third external device.

8. The electronic device of claim 7, wherein the instructions, when executed, cause the processor to:
determine an external device, which will be provided with the response, based on at least part of a type or state of the first external device, a type or state of the second external device, a session lock time of the first session, a session lock time of the second session, a reception time of the first utterance, and a reception time of the second utterance.

9. The electronic device of claim 1, wherein the instructions, when executed, cause the processor to:
release the integrated session based on states of the first external device and the third external device that are associated with the integrated session.

10. The electronic device of claim 9, wherein the instructions, when executed, cause the processor to:
provide a response according to the release of the integrated session to at least one of the first external device and the third external device.

11. The electronic device of claim 1, wherein the instructions, when executed, cause the processor to:
when establishing a new session by integrating the integrated session and a third session between a fourth external device and the second external device, determine whether to separate the first session or the second session from the integrated session based on states of the first external device and the third external device, which are associated with the integrated session.

12. The electronic device of claim 11, wherein the instructions, when executed, cause the processor to:
provide a session separation result to an external device corresponding to a session separated from the integrated session.

13. An operating method of an electronic device, the method comprising:
recognizing a second external device that will perform an operation corresponding to a first utterance received by a first external device;
establishing a first session between the first external device and the second external device;
recognizing a device, which will perform an operation corresponding to a second utterance received by a third external device, while maintaining the first session;
when the device that will perform the operation corresponding to the second utterance is the second external device, determining whether to establish a second session between the third external device and the second external device based on a specified first condition; and
when establishing the second session, on a basis of a specified second condition, establishing the second session independently of the first session or establishing an integrated session between the first external device, the second external device, and the third external device by integrating the first session and the second session.

14. The method of claim 13, wherein the first condition includes whether the operation corresponding to the first utterance is identical to the operation corresponding to the second utterance.

15. The method of claim 13, wherein the second condition includes at least one of a case that the first external device and the third external device use an identical account, a case that a session lock time of the first session has not elapsed, a case that the first external device is activated, and a case that an elapsed time after the first utterance is received is within a specified time.

16. The method of claim 13, further comprising:
setting a session lock time of each of the first session, the second session, or the integrated session based on at least one of information of the first utterance, information of the second utterance, an attribute of the first external device, and an attribute of the second external device.

17. The method of claim 13, further comprising:
when the operation corresponding to the first utterance or the operation corresponding to the second utterance is completed by the second external device, updating a stored session information.

18. The method of claim 13, further comprising:
when the operation corresponding to the first utterance or the operation corresponding to the second utterance is completed by the second external device, providing a response according to the completed operation to at least one of the first external device and the third external device.

19. The method of claim 13, further comprising:
releasing the integrated session based on states of the first external device and the third external device that are associated with the integrated session.

20. The method of claim 13, further comprising:
when establishing a new session by integrating the integrated session and a third session between a fourth external device and the second external device, determining whether to separate the first session or the second session from the integrated session based on states of the first external device and the third external device, which are associated with the integrated session.
